(19) United States
(12) Patent Application Publication
(10) Pub. No.: US 2014/0289611 A1
(43) Pub. Date: Sep. 25, 2014

(54) SYSTEM AND METHOD FOR END USERS TO COMMENT ON WEBPAGE CONTENT FOR DISPLAY ON REMOTE WEBSITES

(71) Applicant: SOCIAL COMMENTING, LLC, Sedona, AZ (US)

(72) Inventors: Michael Roy Norwood, Sedona, AZ (US); Stephen Malvem Omohundro, Palo Alto, CA (US)

(73) Assignee: SOCIAL COMMENTING, LLC, Sedona, AZ (US)

(21) Appl. No.: 14/298,705

(22) Filed: Jun. 6, 2014

Related U.S. Application Data
(63) Continuation-in-part of application No. 13/759,693, filed on Feb. 5, 2013.
Application No. 13/759,693 is a continuation of application No. 11/818,912, filed on Jun. 15, 2007, now Pat. No. 8,402,357.
(60) Provisional application No. 61/832,133, filed on Jun. 6, 2013.
(60) Provisional application No. 60/813,982, filed on Jun. 15, 2006.

(51) Int. Cl. H04L 12/58; G06F 17/30; G06F 17/22

(52) U.S. Cl. CPC H04L 51/046; G06F 17/2247; G06F 17/3089
USPC 715/234; 715/753

(57) ABSTRACT

A webpage commenting solution that involves an end user operating an end user device to access a webpage on a first server. The webpage includes an end user comment submit function. The end user can submit a comment by actuating the end user comment submit function. The first server receives the multimedia comment for the webpage, store the multimedia comment on the system, accesses the multimedia comment for use on the webpage, and transmits (upon actuation of the end user comment submit function and with no need for any other end user action) the multimedia comment to the second server for association with a second identified data record, the second identified data record associated with the end user.

### CROSS-REFERENCE TO RELATED APPLICATIONS

This is a utility patent application being filed in the United States as a non-provisional application for patent under Title 35 U.S.C. §100 et seq. and 37 C.F.R. §1.53(b) and, claiming the priority under 35 U.S.C. §119(e) to the provisional application for patent filed in the United States on Jun. 6, 2013, bearing the title of “SYSTEM AND METHOD FOR END USERS TO COMMENT ON WEBPAGE CONTENT FOR DISPLAY ON REMOTE WEBSITES”, and assigned application Ser. No. 61/832,133.

Further, this application is a continuation in part of U.S. patent application Ser. No. 13/759,693 filed on Feb. 5, 2013, which application is a continuation of U.S. application Ser. No. 11/818,912 filed on Jun. 15, 2007 and issued as U.S. Pat. No. 8,402,357 to Norwood et al., on Mar. 19, 2013 and bears the title of “SYSTEM AND METHOD FOR FACILITATING POSTING OF PUBLIC AND PRIVATE USERS COMMENTS AT A WEBSITE”, which application is a non-provisional application of United States Provisional application for patent filed on Jun. 15, 2006 and assigned Ser. No. 60/813,982.

Each of these above-referenced applications are hereby incorporated by reference in their entireties.

### BACKGROUND

From our earliest memories, we all remember being told that “you have to share” or “its nice to share” or “if everyone shares they will have more”. But none of ever believed it and, most of us still don't. Basically, some may view the concept of sharing as having been created by people that don't have anything. But, this entire non-sharing attitude is focused on our “stuff”. When it comes to our opinions, well that's a whole different story. Rather than constantly being implored to share, we instead repeatedly hear the old adage “keep your opinion to yourself”. But, everyone likes to be heard and, we see people expressing their opinions in all sorts of manners, even if no one is there to listen. These opinions appear on T-shirts, license plates, billboards and more recently, blogs, on-line journals, FACEBOOK posts and TWEETS, to name a few. The multitude of buttons, gadgets, gizmos and other input devices (comment fields, etc.) being used to give Internet and mobile application users the ability to share information, their feelings and thoughts have created a new universe of interactivity on the web.

The Internet began as a medium through which website operators could share their own amassed content; the operators sharing with the end user. With the advent of “social media,” these website operators began to understand that their end users also wanted to share their own content on the operator's website (this could be in addition to or independent of the content shared by the operator). Consequently, bulletin boards, group forums, blogs and other websites devoted substantially to end user sharing (“social media” websites) grew in popularity. These “social media” websites evolved into Friendster, MySpace, Bebo, etc; and a subset of these “social media” websites are tailored specifically for multimedia content, e.g., YouTube, Vimeo, Vevo and Metacafe.

U.S. Pat. No. 8,402,357 describes aspects of the next major development in human digital sharing, such as “social media” as an example. Such aspects later appeared on the web in 2009 with Facebook's release of the “Like” button. The use of such “third party buttons” now proliferated on the web by so many social media giants such as Twitter, LinkedIn, Tumblr and Pinterest, is testimony to the importance of these end user-input sharing devices.

This phenomenon of remote website end user inputs to a centralized website database is a comparable to the leap of a young bird leaving the nest and learning to fly. No longer needing to be suckled, the bird gains the capability of bringing its own food back to the nest independent of its mother.

In Internet terms, this simply means end users are no longer confined to a single centralized website to share information, thoughts and feelings. They can leave “the nest” (the social media website) and automatically have things discovered away from the social media website along with their thoughts and feelings about those things instantly sent back to that centralized home base (the “nest”).

Despite these extraordinary advances, there still exists a great limitations to this evolution. These limitations include the fact that not every webpage or every element on every webpage on the Internet has such website administrator generated features allowing such sharing by end user visitors to occur.

### SUMMARY

The present disclosure relates generally to software applications for annotating webpages or providing comments related to particular content and, in particular, techniques that allow a viewer of an item, such as a website or other items, to create and post comments related to the content that can be accessed by the user or others. The present disclosure presents exemplary embodiments of multiple systems and methods that can be utilized by website administrators or others to facilitate an end user having the ability to create comments (audio, video, image, and/or textual) and have those comments posted for others. For instance, posted on the administrator's website and/or posted on a remote third party website. As such, the present disclosure relates to a computerized system for and method of annotating content on a webpage and, more particularly, to an improved computerized system for and method of commenting by the end user of the webpage; the comment capable of being posted on a server hosting a third-party website.

The present disclosure describes various embodiments, as well as features and aspects thereof, of a solution to enable a user that is viewing content on a webpage (referred to as an end user, viewer, reader etc.) to create and/or select comments related to the content and to have those comments posted on a current and/or on a different website, such as a third-party website. The various embodiments described herein are collectively referred to as a content commenter. Various aspects and functions are presented in the described embodiments, some of which include facilitating:
(1) the creation and/or posting of comments related to audio and/or video (or other multi-media content) that are present on the viewed webpage;
(2) the posting of multi-media comments related to website content;
(3) the generation of revenue for the operator of the webpage of which an end user is commenting;
(4) the creation/posting of further comments related to previously posted comments, with such new comments being created/posted by the same or a different end user than the one creating the previously posted comments;
(5) the simultaneous/semi-simultaneous posting of end user comments on multiple third party “social media” websites;
(6) the transmission of the end user comments to a centralized database (e.g., the end user's Facebook or Twitter account); and/or
(7) the retention of the end user comment on the webpage for purposes of “search engine optimization.”

Thus, the current disclosure expands the use of comment sharing features through a plurality of new revolutionary sharing features and/or functions. The first two features have to do with another explosion of interactivity that has occurred on the web: that of video sites. Starting with the explosive launch of YouTube in 2005 rapidly evolving into hundreds of other video-sharing sites such as Vimeo, Vevo and Metacafe, the human desire to express feelings, thoughts and information in as close to real-life form has brought the web to a new stage of evolution.

Various embodiments provide a new and simpler bridge of these two combined phenomenon of video (and audio) sharing and sharing thoughts, feelings and information from a remote website to a central website database. Various embodiments will enable users to more easily and effortlessly—literally with the click of a submit mechanism such as a button, as a non-limiting example—be able to share videos and audios from any website in the world back onto one centralized database and website (e.g. Facebook, LinkedIn, Twitter).

Other components that may exist in various embodiments expand the revolutionary features described in U.S. Pat. No. 8,402,357 in a way that creates even more uses for the features described in that patent. These new components include expanding the features of U.S. Pat. No. 8,402,357 into the arena of “sponsored commenting” where comments can be used as a direct income source by website administrators allowing comments. Other components described in this application include commenting on multiple comments and commenting by geo-location.

And further, various embodiments may include a new way that allows users to virtually share any element on any webpage on the internet, independent of a website administrator having placed code on that webpage as described in U.S. Pat. No. 8,402,357, to allow transmission back to a centralized database, such as the user's Facebook or Twitter account

This frees end users from the limitations of having to wait to arrive and check in at the next website administrator generated “check-in post” to submit some form of an input such as a comment (the equivalent, as a non-limiting example, of clicking a website administrator generated Facebook “Like”, Twitter or Google+ button). Instead, the various embodiments may turn complete control over to the actual end user visitor independent of a website administrator placing code from a centralized website (Facebook, Twitter and Google, as examples). Further, embodiments may allow the end user visitor to report their location, comments and information into one or more centralized databases of their choosing from any webpage on the Internet.

This component, which may be included in any of the various embodiments, not only benefits the end user. It also benefits the centralized database administrator (e.g. Facebook, Twitter, and Google). Some embodiments may allow these centralized database sites to collect invaluable data about their end users without the limitations of website administrators placing code from the centralized database site onto their own individual website. Such embodiments provide the equivalent function of a biologist placing a GPS tracker on a bird or other animal. This adds invaluable information to the “data-cube” about individual users. Depending upon how often the end user chooses to provide inputs into the mobile input device, the day-to-day, minute-to-minute and even second-to-second habits of each user can then be aggregated and analyzed to provide an exponentially more valuable picture of both individual and collective users than the very static data obtained from a filled out “user profile” input form. This type of travelling end user input device is even more flexible and expansive in scope than the vital collection of data obtained from the invention described in U.S. Pat. No. 8,402,357.

The embodiments disclosed herein may directly or indirectly derive from the inventions disclosed in U.S. Pat. No. 8,402,357).

More specifically, one non-limiting embodiment of the content commenter includes a first server hosting a webpage. Through out the description, the first server for several embodiments will also be referred to as the viewed website server and as such, these terms may be used interchangeably. The first server is communicatively coupled to a network and the network is communicatively coupled to an end user device and a second server. The first server hosts at least a website that includes one or more webpages and, at least one webpage has an end user comment submit function associated with content on the webpage, such as multimedia content. The second server hosts a third party website with a webpage that can receive and accommodate the posting or display of received comments. Throughout the description, this second server will also referred to in some embodiments as the target website server in that comments entered at the viewed website server and then provided to the target website server. It should also be appreciated that a single website may operate as both a viewed website and a target website. In the various embodiments, the comment submit function may be configured as follows:
(1) a static or dynamic feature, marker or module that operates invoke or prompt for a comment (similar to the Like button on FACEBOOK);
(2) accessible to be actuated by an end user on an end user device; and
(3) operable to create a multimedia comment.

The first server includes a general computing platform communicatively coupled to a database. The database may be configured to store the comment or multimedia comment and to associate the multimedia comment with the end user. For instance, this association can be accomplished by utilizing a data record that is associated with the end user as a non-limiting example. The general computing platform may include a processor, a memory device, and a network interface with all three being communicatively coupled to one another. The memory device is configured to store electronic programming, and the processor is configured to retrieve and execute the electronic programming. Through the electronic programming, the first server is configured to:
(1) receive the comment related to content on the webpage, either in response to, or prior to a user actuating a user comment function, the comment may be a multimedia comment;
(2) store the comment in a manner accessible by on the first server;
(3) access the comment for use on the webpage; and
(4) transmit, (i.e., upon actuation of the end user comment submit function), the comment to a second server for association with the end user and/or display.

Various embodiments of the content commenter are described in more detail in the detailed description with reference to the attached drawings.

### BRIEF DESCRIPTION OF THE DRAWINGS

FIG. 1A is a block diagram representing an exemplary environment suitable for one or more embodiments of a content commenter.

FIG. 1B is a block diagram illustrating an exemplary physical architecture of the internal components of an electronic computing system that could serve as the platform for an end user device, administrator's device, etc.

FIG. 2A is a flowchart diagram outlining one or more exemplary embodiments of a content commenter that comprise one or more end user's computing devices in communication with a first website server/device (e.g. website administrator's computing system) via a network.

FIG. 2B is a flowchart outlining one embodiment of a commenting process described from the perspective of a second server that is hosting the target website.

FIG. 3A is a flowchart illustrating exemplary actions than can be included in an implementation of an exemplary embodiment of the content commenter.

FIG. 3B is a flowchart outlining this embodiment as depicted from the perspective of the second server.

FIG. 4A is a flowchart outlining exemplary actions for an implementation of this embodiment of the content commenter.

FIG. 4B is a flowchart diagram presenting exemplary actions that may be included in an implementation of this embodiment.

FIG. 5A is a flowchart presenting exemplary actions that may be incorporated into an implementation of this embodiment.

FIG. 5B is a flowchart diagram presenting exemplary actions that may be incorporated into an implementation of this embodiment.

FIG. 6A is a flowchart diagram illustrating exemplary actions that may be implemented in this embodiment.

FIG. 6B is a flowchart outlining aspects of this embodiment from the perspective of the target website server.

FIG. 7A is a flowchart presenting exemplary actions that may be included in various embodiment of the content commenter.

FIG. 7B is a flowchart diagram illustrating further exemplary actions that may be included in the embodiment presented in FIG. 7A.

FIG. 8 is a flowchart illustrating the method of sending comments from an end-user's account on a third party server to multiple websites simultaneously.

### DETAILED DESCRIPTION OF VARIOUS EMBODIMENTS

The following written description explains various embodiments of the content commenter. This written description refers to the appended drawings to supplement the written explanation and, as such, the written words should not be construed as limitations. Numerous specific details are explained in the written description and depicted in the drawings to provide an enabling understanding of the various embodiments. Some details, however, need not be expressly explained because they would be readily apparent and understood by one of ordinary skill in the art (e.g., for certain described embodiments, explanation of some specific details are omitted so as to not unnecessarily obscure the written description). Additionally, one of ordinary skill in the art could understand that the various embodiments may be practiced without some or all of these specific details.

Although throughout the detailed description, the various embodiments are directed towards a content commenter, it should be understood that the focus of such description is only provided to ensure clarity in the configuration and operation of the various embodiments, and the description should not be used to limit the usefulness of the various embodiments in other manners or for other uses.

The various embodiments shown and described herein may be ideally suited, without limitation, to:

(1) the creation and/or posting of comments related to audio and/or video (or other multi-media content) that are present on the viewed webpage;
(2) the posting of multi-media comments related to particular content;
(3) the generation of revenue for the operator of the viewed webpage of which an end user is commenting and/or the target website at which the comments are posted;
(4) the creation/posting of further comments related to previously posted comments, with such new comments being created/posted by the same or a different end user than the one creating the previously posted comments;
(5) the simultaneous/semi-simultaneous posting of end user comments on multiple third party “social media” websites;
(6) the transmission of the end user comments to a centralized database (e.g., the end user's Facebook or Twitter account); and/or
(7) the retention of the end user comment on the webpage for purposes of “search engine optimization.”

### System Architecture

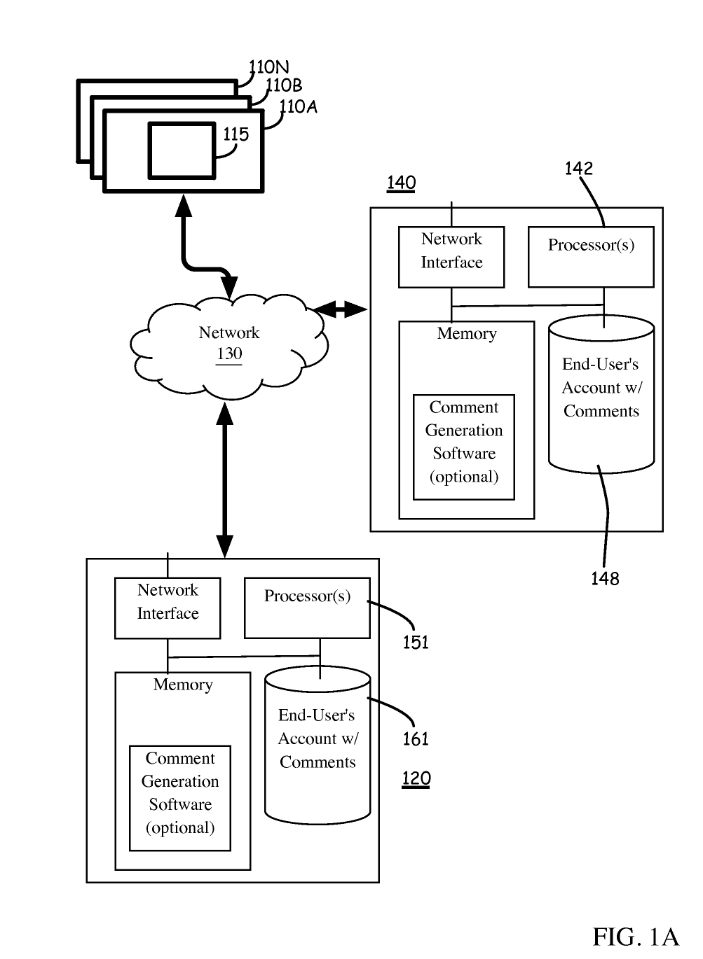

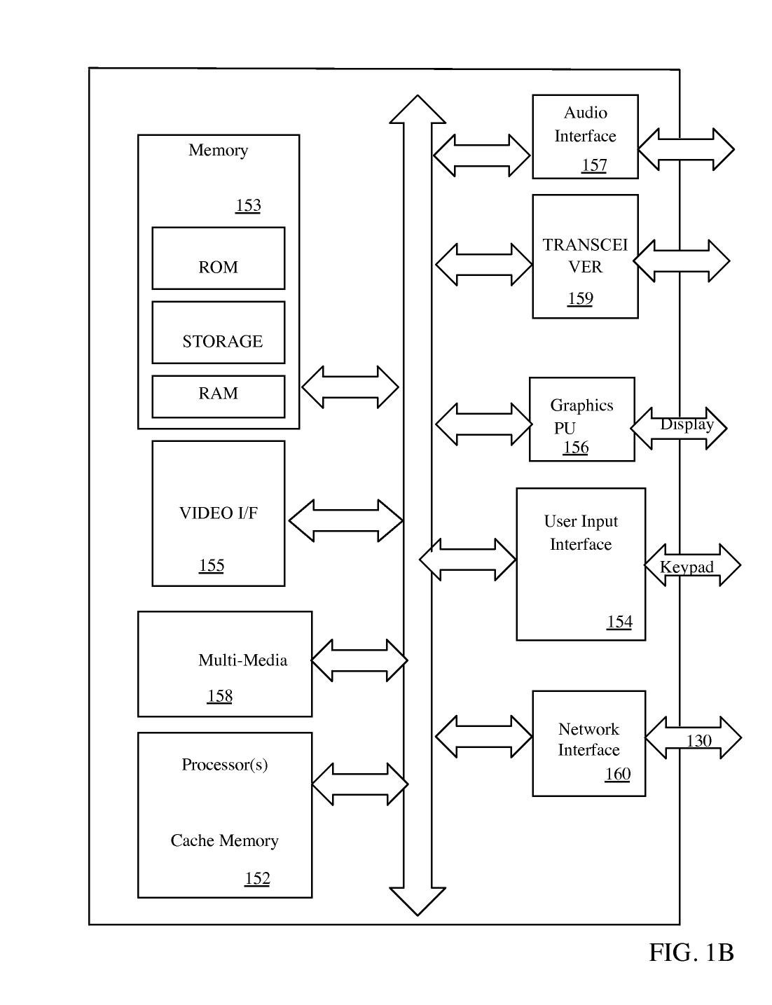

FIG. 1A is a block diagram representing an exemplary environment suitable for one or more embodiments of a content commenter. The illustrated environment includes one or more end user computing devices 110A, 110B . . . 110N that are communicatively coupled to a network 130. Further, a first website server/device 120 (e.g. the viewed website server or a server that hosts a website consisting on one or more webpages with web content and operated by administrator's computing system) and a second website server 140 (e.g. target or social networking server) are also shown as communicatively coupled to the network 130.

It should be appreciated that system components illustrated in the exemplary environment:
(1) may be a sub-system of a larger and/or more complex system and/or network (e.g., the Internet and a LAN);
(2) is one non-limiting embodiment of the functional architecture configured to run embodiments, or portions of embodiments, of the content commenter;
(3) may include other physical elements not depicted;
(4) illustrate physical elements that may or may not be necessary for the system to run some or all of the embodiments, or portions of embodiments;
(5) illustrate physical elements that may or may not be necessary for the system elements to operate in their intended capacities;
(6) illustrate physical elements that are merely one non-limiting embodiment of their respective selves;
(7) are merely one non-limiting embodiment of their respective selves; and
(8) are described as being communicatively coupled but, such term does not necessarily imply a fixed physical or continuous connection but rather may additionally imply any arrangement of functional architecture as a means for communicating date from one point to another.

The system 100 is depicted as having a functional architecture comprising one or more end user devices 110, a first server 120 hosting a website, a network 130 and a second server 140 hosting another website. In general, an end user device 110 is utilized to view the website hosted by 120 (the viewed website), create/submit comments related to content on the viewed website that are destined to be made available to, or displayed upon the website hosed by the second server 140 (the target website). It should also be understood that aspects of the various embodiments may also be implemented outside of, or at least partially outside of the Internet and/or network configuration. For instance, rather than the first server presenting content on a website, this functionality can be described as a sub-system that presents content of any form in any manner. For example, the subsystem may be a cable TV or set-top box receiver such as APPLE TV or ROKU that receives content and presents the content on a monitor. Also, the sub-system may be a marquee at an auction or show presenting various forms of content. The sub-system may even simply constitute a display of items, such as in a store, store window, museum, etc. The sub-system may also be a projection theater type environment projecting the content on a screen for public viewing.

It should also be appreciated that the second server may also be described as a sub-system. Finally, rather than a first sub-system and a second sub-system, there may also exist a third sub-system that implements portions of certain embodiments. For instance, in a general embodiment, content is presented to a viewer, comments are received from the viewer and comments are presented for others. In a three sub-system architecture, it should be appreciated that a first sub-system may present the content, a second sub-system may receive the comments and a third sub-system may present the comments to others or otherwise provide access to the comments. Further, in various embodiments, the functionality presented in this example may be allocated in several manners. For instance, the functionality of the various sub-systems may be combined in any one or more of the following ways: first and second subsystems, second that third subsystems, first and third sub-system and/or first, second and third subsystem. For instance, in the typical embodiments presented herein, the first and second sub-systems could be represented by the first server and the third sub-system could be represented by the second server, as a non-limiting example.

It is envisioned that end user device 110 comprises an electronic computing system 115 (software and suitable hardware) (described more fully infra). Electronic computing system 115 of the end user device 110 is configured to process electronic programming, and is communicatively coupled to and communicatively coupled through network 130 such that the end user device 110 interfaces with the first server 120 (i.e., accesses the viewed website) and the second server 140 (i.e., accesses the target website). Non-limiting examples of end user devices 110 include laptop computers, desktop computers, servers, tablets, mobile electronic communication devices (e.g., smartphones, cellular phones and personal digital assistant devices), etc. The end user device 110 may additionally comprise a network like network 130 (described more fully infra) and may have several electronic computing systems communicatively coupled over this network. Although in most of the embodiments described herein, the end user device 110 is described as a computing system, it will also be appreciated that other configurations are also anticipated. For instance, the end user device may simply be a smart phone with a camera that is used to point and click to obtain a picture of an item and then allow various types of commenting to be attached such as text, voice, video, etc. For instance, a picture of content presented on a screen may be snapped as a comment and/or as content to be commented upon.

Furthermore, it is envisioned that the first server 120, hosting the viewed website, comprises an electronic computing system 151 (software and suitable hardware) and a memory element such as a database 161 (described more fully infra) configured to process electronic programming, to respond to requests across a network, to provide/support administrator control and/or to facilitate a network service (e.g., website hosting) for other network elements. The first server 120 hosts the viewed website. The first server 120 may additionally comprise a network like network 130 (described more fully infra) and may have several electronic computing systems communicatively coupled over this network.

The first website server 120 is configured to display webpages (viewed website) modified to receive data input for and display end user's comments, and transmit the data to a second website server 140 for other purposes, such as storage in a database as a non-limiting example. The server 120 may comprise all or part of the hardware and software necessary for communicating via the network 130 to end user's device 110 and the remote server 140. In one embodiment, the server 120 is housed with a computing device with web browser capabilities and other computing functionality as disclosed herein for the end user's device 110. As such, the viewed website is configured to provide a content commenting function, which in some embodiments may include the reception of a multimedia comment from the end user device 110. Further, the first website server is configured to then post the multimedia comment to the second server 140.

Even furthermore, it is envisioned that network 130 is any system (software and suitable hardware) comprising network elements such as the Internet or the World Wide Web, any public or private local network or any similar public or private local network that may be developed in the future or that is a hybrid of those presently available. A public or private local network may be a local area network (LAN), wide area network (WAN), WI-FI network, cellular telecommunications network, satellite telecommunications network, microwave telecommunications network, infrared telecommunications network, radio telecommunications network, etc.

Network 130 is, at least in part, the physical infrastructure configured to relay a communication between network elements such that end user device 110 is communicatively coupled to first server 120 and second server 140. Network elements of network 130 may include the Internet and/or other types of data networks like a LAN, a WAN, a WI-FI network, a cellular telecommunications network, a satellite telecommunications network, a microwave telecommunications network, an infrared telecommunications network, a radio telecommunications network, Ethernet, 802.11a/b/g/n/ac, worldwide interoperability for microwave access (WiMAX), 3G, 4G, CDMA, CDMA+, digital subscriber line (DSL), etc. The communication relayed via network 130 may be JavaScript, Asynchronous JavaScript, hypertext markup language (HTML), Cascading Style Sheets (CSS), extensible markup language (XML), etc.

Furthermore, it is envisioned that the second server 140, hosting the target website, comprises an electronic computing system 142 (software and suitable hardware) a database 148 (described more fully infra) configured to process electronic programming, to provide/support administrator control, to respond to requests across a network and/or help to provide a network service (e.g., website hosting) to other network elements. The second server 140 may host the targetwebsite configured to receive a comment that is associated with a user of the end user device. The comment could be received from the end user device 110 or from the first server 120. The second server 140 may additionally comprise a network like network 130 (described more fully supra) and may have several electronic computing systems communicatively coupled over this network. The remote second (third party) website server 140 comprises one or more processors and memory to execute applications to provide computing services, such as cloud-based computing services or other types of service, to first website servers 120 via network 130. The server 140 may further comprise a database for storing data (e.g. a comment on content of a webpage of a first website server 120) transmitted from end user's devices 110 via a web-browser. The database may store the transmissions within records associated with end users on the second server 140.

FIG. 1B is a block diagram illustrating an exemplary physical architecture of the internal components of an electronic computing system that could serve as the platform for an end user device, administrator's device, etc. Thus, the illustrated architecture could illustrate an electronic computing system for an end user device 110, first server 120, second server 140 respectively, or any other network element (described more fully supra). The physical architecture may include general computing platform 180 comprising a processor 152, a memory device 153, a user input interface 154, a video interface 155, a graphic processing unit 156, an audio interface 157, a video, camera and/or recording or multimedia interface 158, a transceiver 159 and a network interface 160.

The processor 152 may be a variety of processor types including microprocessors, micro-controllers, programmable arrays, custom ICs, etc. and may also include single or multiple processors with or without accelerators or the like. The processor 152 may optionally contain a cache memory unit for temporary local storage of instructions, data or computer addresses. The processor 152 may be implemented as a single-chip, multiple chips and/or other electrical components including one or more integrated circuits and printed circuit boards.

The memory device 153 encompasses one or more storage mediums and generally provides a place to store electronic programming (e.g., software and/or firmware). The memory element 153 may include various tangible and non-transitory computer-readable media like random access memory (RAM), read only memory (ROM), magnetic media, optical media, bubble memory, FLASH memory, etc. Generally, it is well known in the art that ROM acts to transfer data and instructions uni-directionally to the processor 152, while RAM acts to transfer data and instructions in a bi-directional manner. Furthermore, the memory device 153 may include a floppy disk, CD-ROM, DVD, magnetic disk, memory chip, ASIC, FPGA, nonvolatile memory (e.g., EPROM or EEROM), etc. Even furthermore, memory element 153 may comprise, for example, electronic, optical, magnetic, or any other storage or transmission device configured to provide processor 152 with electronic programming.

The processor 152, together with suitable software (e.g, an operating system), is configured to execute electronic programming (e.g., computer code) to manipulate, compute and transform data inputs into data output. The processor 152 and the memory device 153 may be integrated or communicatively coupled over a bus 182 or other similar interface. For example, using electronic programming retrieved from the memory device 153, the processor 152 may control the reception, manipulation, computation and/or transformation of input data transmitted from elements of the computing platform 160 such that the processor 152 and the memory device 153 perform one or more of the computerized methods described infra.

The processor 152 is generally communicatively coupled to a variety of elements like the user input interface 154, the video interface 155, the graphic processing unit 156, the audio interface 157, the video, camera and/or recording interface 158, the transceiver 159 and the network interface 160 such that the general computing platform 160 is configured to capture, record, collect, transmit etc. digital photos, audio and video data. The interface 154 may be communicatively coupled with a touchscreen data input, a keypad, etc. Similarly, the video, camera and/or recording interface 158 may be communicatively coupled to camera hardware (with suitable software components). The transceiver 159 and/or the network interface 160 may be utilized by the general computing platform 160 in communicating with a network for the transmission and reception of digital photos, audio and video data. The processor 152 and/or other elements of the general computing platform 160 may be configured to function as a real-time clock, analog to digital convertor, digital to analog convertors, etc.

The user input interface 154 provides an interface to external controls, e.g., sensors, actuators, drawing heads, nozzles, cartridges, pressure actuators, leading mechanism, drums, step motors, keyboards, mice, pin pads, touch pads, audio activated devices, other available input and output devices. The graphic processing unit 156 may include a module configured to facilitate operating and commanding an external display/touchscreen like an LED display, an LCD display, one or more LEDs or other display devices. Similarly, audio interface 157 is configured to operate and command a speaker, a speaker system, a buzzer, a bell, etc.

The transceiver 159 may be communicatively coupled to an antenna/receiver to receive and/or transmit data through a network. The transceiver may operate according to standards, known to one having ordinary skill in the art, like GSM, GPRS, wireless local and personal area network standards, and Bluetooth. Relatedly, the network interface 160 is configured to facilitate the reception and transmission of communications through network 130, and other networks, in the course of performing various method steps described in the embodiments herein. Through the network 130 and network interface 160, or directly through another similar elements, computing platform 151 is communicatively coupled to other devices or network elements like first server 120 or second server 140.

Through the above described functional architecture, the various embodiments of the computerized method of commenting by an end user of a webpage, the comment capable of being posted on a server hosting a third-party website, are possible.

### Social Commenting Embodiments

The remaining figures are flowchart diagrams describe various exemplary embodiments that are presented to illustrate various aspects that may be included in one or more embodiments of the content commenters.

In general, a website administrator may insert web browser computer code (e.g. HTML/CSS/JavaScript) into their webpages (the viewed website) to enable certain functionalities. For instance, a website administrator may obtain source code from the administrator or owner of a second website (the target website), such as a social media platform (FACEBOOK, TWITTER, LINKEDIN, INSTAGRAM, etc), a communication platform (GMAIL, YAHOO MAIL, LINKED, GMAIL CIRCLES, etc), a general information platform such as (GOOGLE, WIKIPEDIA, ASK, etc) or other similar platforms. The code may, for example, enable an end user that is visiting or viewing the content of the webpage using a web browser, to input a comment related to the viewed webpage or specific content on the website. The comment, as a non-limiting example, may be related to the end user's opinion of content on the viewed website. Upon submission of the comment (enter), the data is transmitted to a website server that is affiliated with the target website. The comment can then be displayed at the target website and/or stored on the second server but affiliated with the end user or the end user account (e.g. Facebook account). Through this method, website administrators permit end users of the target websites to express interest in webpages hosted on websites external to the third party system (viewed websites). These comments may then be displayed on the target websites as a result of embedding a widget, a plug-in, programmable logic or code snippet into the viewed website, such as via an iFrame substitution.

In one embodiment, an “iFrame” substitution process is used to allow this remote hosting of the end user's comments. The iFrame substitution provides a simple “window” to the server and database where all reader comments are actually entered, stored, and posted. However, they are also a part of the local site. It is important for the actual text of the posts to be a part of the local site (i.e., the administrator's website) rather than just being reflected to the third party website so that the administrator gets the benefit of using incoming posts for search engine optimization. The administrator does not receive this benefit if the text in the posts is not actually on the local site and remains solely in the remote database of the third party.

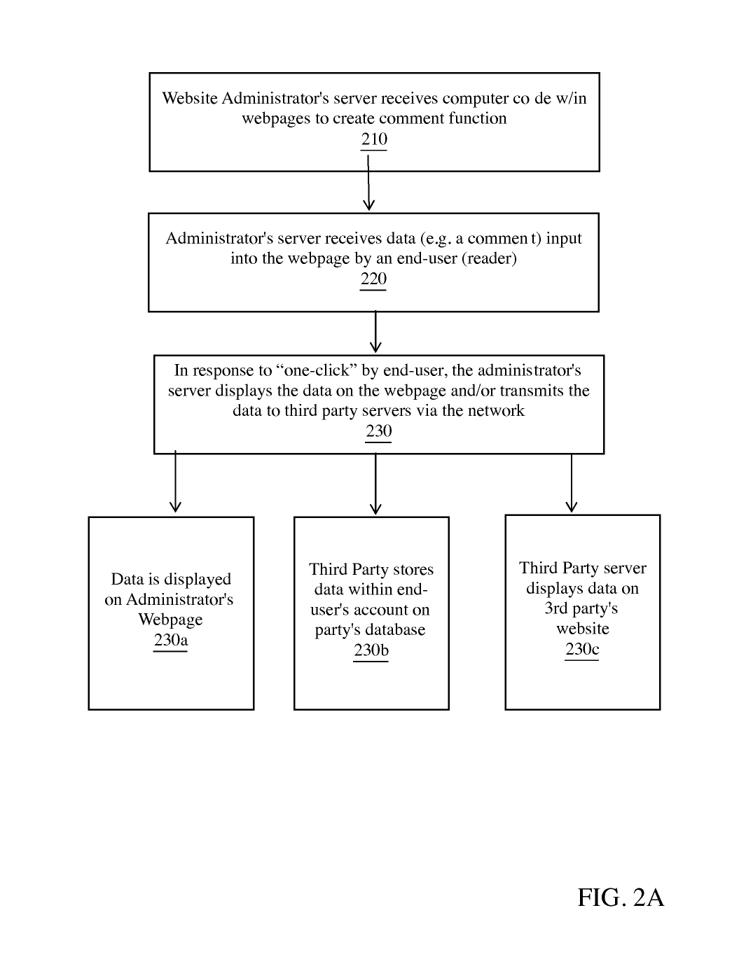

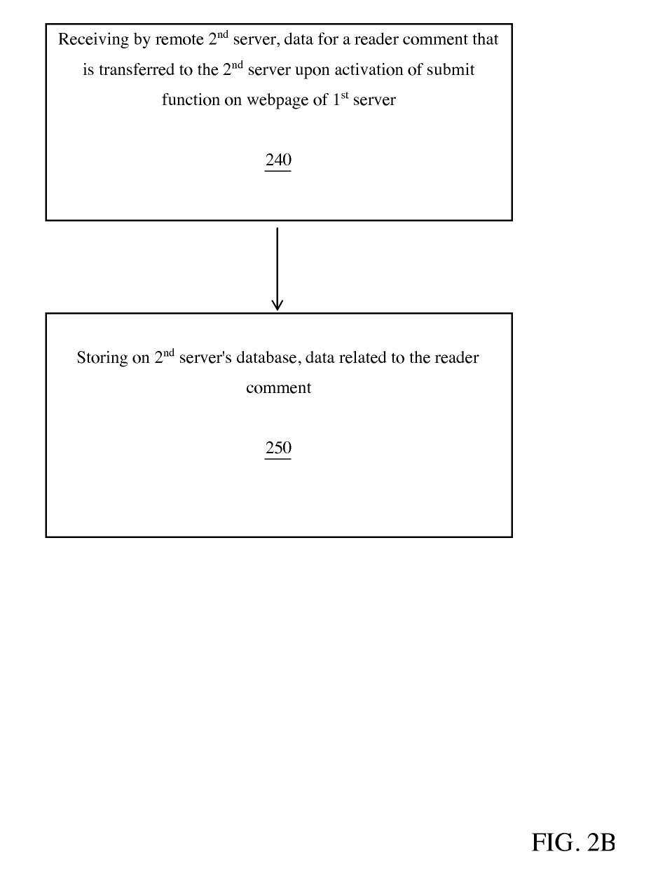

FIG. 2A is a flowchart diagram outlining one or more exemplary embodiments of a content commenter that comprise one or more end user's computing devices in communication with a first website server/device (e.g. website administrator's computing system) via a network. The process illustrated in FIG. 2A is described from the perspective of the first server 120 hosting the viewed website. The first server 120 is configured such that:
(1) a webpage of the viewed website is modified include an end user comment submit function (step 210);
(2) the first server 120, via the end user comment submit function, can receive an end user comment (step 220); and
(3), in response to a “submit” action by the end user on the end user comment submit function 230, the first server 120:
   (a) displays the end user comment (step 230a);
   (b) transmits, via network 130, the end user comment to second server 140, second server 140 hosting a third-party website, for storage in the end user's digital account (step 230b); and/or
   (c) transmits, via network 130, the end user comment to second server 140 for display on a webpage of the third-party website (step 230c).

FIG. 2B is a flowchart outlining one embodiment of a commenting process described from the perspective of a second server that is hosting the target website. The second server 140 is configured to:
(1) receive an end user comment transmitted through network 130 (step 240); and
(2) store in a manner affiliated with the end user's account the end user comment (step 250).

In FIGS. 2A-2B, the system 100 is configured to relay, manage, compute and/or process a comment created by, provided by or selected by the end user. The end user comment is capable of being stored, managed, computed and/or processed at one, or both, of the servers hosting the viewed website or the server hosting target website (such as a “social media” website). A person having ordinary skill in the art will understand that relaying, managing, computing and/or processing a comment from the end user may involve the transmission and/or reception of textual data (via email, SMS, IM, online website input, etc.), audio data (received via microphone, speakers, etc.), video and camera images data (received via camera, photosensors, etc.) from end user device 110.

The viewed website on the first server 120 and/or the target website on the second server 140 is configured to display the comment and/or to receive data related to the comment. In one non-limiting embodiment, the graphic processing unit 156 may include a graphics rendering module configured to perform various tasks related to calculating and displaying the comments at a set frame rate, etc. In another non-limiting embodiment, the iFrame (Inline Frame) may be utilized to create an HTML document embedded inside another HTML document on one or both of the first server 120 and the second server 140. The “iFrame” substitution processes may be used to allow the remote hosting of end user comments and to provide a “window” into the network element/database where all comments are actually entered, stored, and/or posted. Comments, however, are also a part of the local operator website such that the operator may receive the benefit of incorporating comments for the purpose of “search engine optimization.”

Any combination of an end user device 110, the first server 120, the second server 140 and any other element of network 130 may comprise a database for storing comment data. The database may be configured to store the comment data within specifically identified data records, e.g., a digital account specific to an end user of operator's webpage on one or both of first server 120 and second server 140.

The system 100 is further configured to receive at the first server 120, for example, comment data. The comment data may then be relayed through the network 130 to the second server 140 upon, or in response to, the end user actuating a submit function that is displayed on or accessible through the viewed website. The system 100 may be further configured to store the comment data on the database associated with the target website. The submit function may comprise any single end user action or a more complex computerized process know to those of ordinary skill in the art. The end user actions of this sort may include one/multiple user's inputs, responses, “one-click”, etc.

The end user device 110, the first server 120, the second server 140 and any other element of network 130 may further include a module comprising a native application, a web application and/or a widget type application to carry out the functionality of the various embodiments. They may include a web browser running application (e.g., Java applets or other similar applications) comprising an application programming interface (“APIs”) to other software applications running on any other element of network 130 that provides, for example, cloud based services and commenting features.

In one non-limiting embodiment, a native application (e.g. computer program product) may be installed/pre-installed/downloaded/etc. via network 130 etc. onto the device and activated. Moreover, the native application may be written in an appropriate coding language to run on a variety of different platforms or it may be written in a platform-specific language. In another non-limiting embodiment, a web application may reside on the first server 120, the second server 140 and/or any other element of the network 130. It may be configured to perform basically all the same tasks as a native application (usually by being downloaded, fully or in-part, for local processing each time it is used). Generally, the web application software may be written as a webpage in HTML, CSS and/or any other language serving the same purpose with the interactive parts possibly in JavaScript, etc. The web application software may comprise a widget as a packaged/downloadable/installable web application that makes it more like a traditional application than a web application; however, like most web application, the web application software may be configured to utilize HTML/CSS/JavaScript. Further, the user device 110 or the first server 120 may include a web browser running applications (e.g. Java applets or other like applications), comprising application programming interfaces (“APIs”) to other software applications running on remote servers that provide, for example, cloud based services and comment posting.

Additional embodiments of the content commenter are described in greater detail infra. The additional embodiments may comprise variations, modifications and/or different combinations of the functional system and methods described supra as well as additional modifications and functions.

### Embodiment (1)

### Video and Audio Submit Device (e.g. Button)

In this particular embodiment, the first server 120, hosting the viewed website, incorporates electronic programming such that a webpage of the viewed website is modified to have an end user comment submit function related to the webpage content. The modification may include inserting a comment actuator, such as a distinguishing feature, marker, or other indicia, as well as or alternatively, a hidden or subtle feature that is activated or may become more pronounced on a mouse-over event. When activated, a module or function can be initiated or a command can be sent to cause such initiation. The comment actuator is typically associated with a portion of the webpage content, such as an image, video and/or audio content included within the webpage or application. It should be appreciated that throughout this description, the term comment actuator can be applied to the modification to a webpage that allows the viewer of the webpage to invoke a commenting function as well as the underlying routine, module or function that results from the actuation.

As a non-limiting example, the comment actuator may be an additional image layer embedded into, overlaid on top of, and/or surrounding the image, video and/or audio content such that, when activated (e.g. clicked upon) by the end user reader invokes an action. For instance, actuation of the comment actuator may function to submit an end user comment to the first server 120. For example, when the only action taken by the end user and/or website operator is clicking, with no other keyboard input, the comment actuator may function to submit an end user comment to the first server 120. In another non-limiting example, actuation of the comment actuator may bring up a comment field and/or button for further keyboard input from the end user and/or website operator, and/or actuate the transmission of the end user comment to a second server 140 and/or any other element of network 130.

As another non-limiting example, the comment actuator may be configured such that when the end user and/or the website operator actuates the comment actuator, the comment actuator relays the particular content (i.e., image, video and/or audio) or a link thereto, to the second server 140 hosting the target website. The received content can be displayed and/or stored at the second server 140 or, some other action may be taken with regards to the content.

The comment actuator may comprise a variety of digital visual indicators such as being in the form of a color or patterned border around the multimedia content, an audible notice that is sounded upon mouse-over, a visual indicator that occurs at mouse-over, or some other visual and/or audible indicator that is perpetually available or that only occurs upon mouse-over.

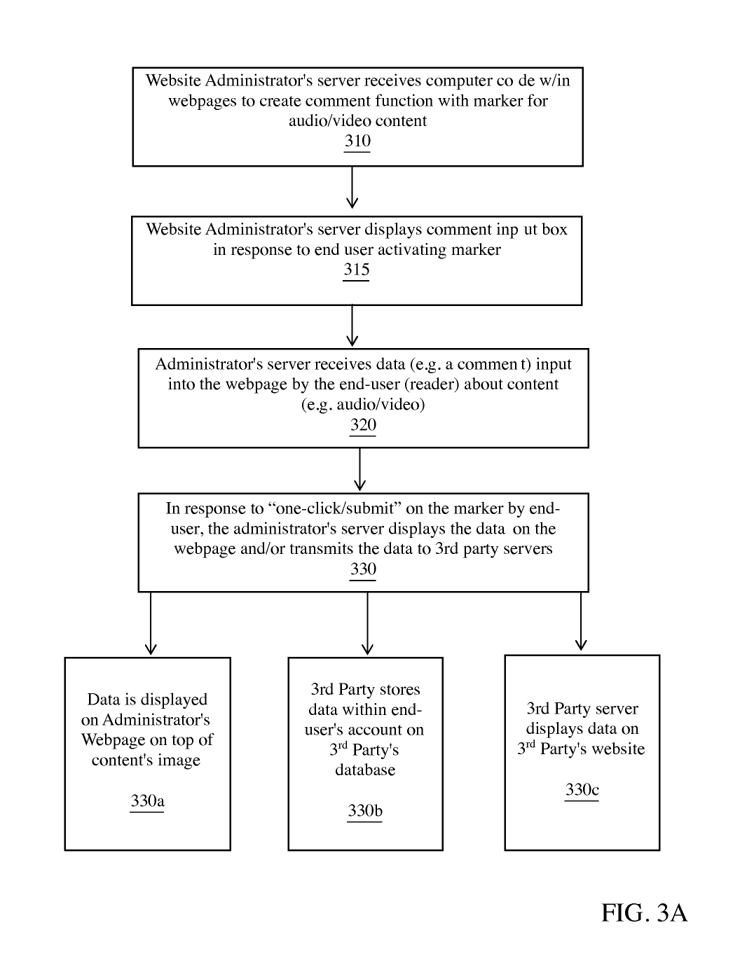

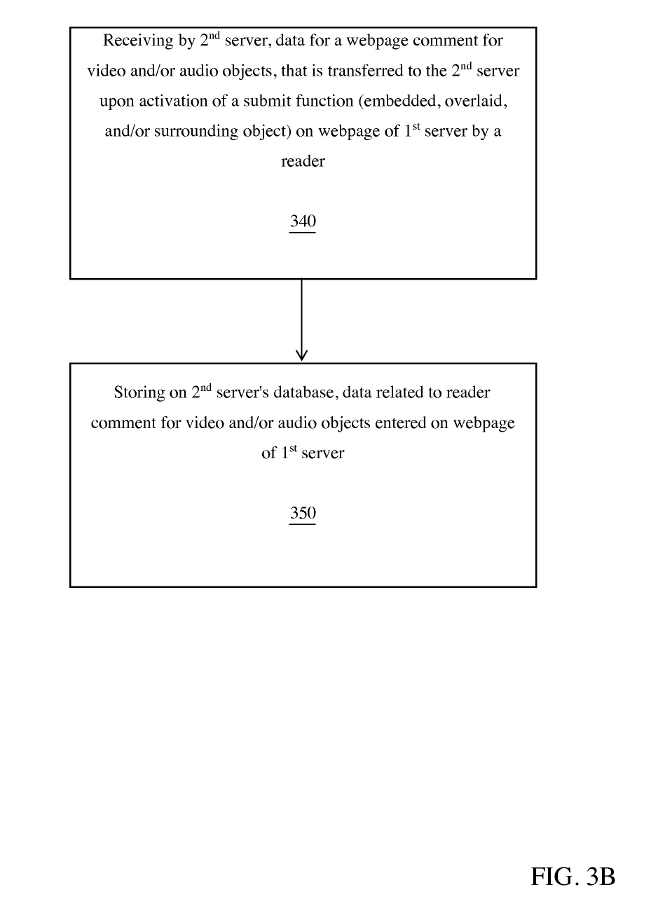

FIG. 3A is a flowchart illustrating exemplary actions than can be included in an implementation of an exemplary embodiment of the content commenter. The actions depicted in FIG. 3A are viewed from the perspective of first server 120. The first server 120, hosting the viewed website, incorporates electronic programming such that:
(1) a webpage of viewed website is modified to include a comment submit function (step 310) comprising a comment actuator;
(2) the first server 120 is configured, via the end user comment submit function, to receive an end user comment (step 320); and
(3) the first server 120:
   (a) displays, in response to a “submit” action (e.g., “one-click” function or other actuation) by the end user on the end user comment submit function, the end user comment (step 330a);
   (b) transmits, via network 130, the end user comment to the second server 140 hosting the target website for storage in a manner that is associated with the end user and/or an account of the end user (step 330b); and/or
   (c) transmits, via network 130, the end user comment to the second server 140 for display on target webpage (step 330c).

Optionally, first server 120 may be configured such that first server 120 displays, in response to the actuation by the end user on the end user comment submit function, a comment field capable of receiving end user and/or website operator input. Alternatively, the comment field does not require actuation to be displayed (step 315).

FIG. 3B is a flowchart outlining this embodiment as depicted from the perspective of the second server 140. The second server 140, hosting the target website, incorporates electronic programming such that:
(1) the second server 140 receives an end user comment related to content of the viewed website (i.e., video and/or audio objects associated with the comment actuator) (step 340); and
(2) the second server 140 stores in an end user's digital account the end user comment and/or the particular image, video and/or audio content (step 350).

### Embodiment (2)

### Mouse Over Submit Device (e.g. Button)

In this particular embodiment, the first server 120, hosting a viewed website, incorporates electronic programming such that a webpage of the viewed website is modified to have an end user comment submit function related to at least some of the webpage content (e.g., inserting a comment actuator). The comment actuator in this embodiment is passive in that it appears upon the end user performing an action, such as scrolling-over the comment actuator using an input source or pressing a particular key. The passive comment actuator is distinguished from other comment actuators in that it does not readily appear to be present until some other action takes place, such as a mouse roll over, the pressing of a function key, the toggling of a flag of function button (such as the paragraph marker in MICROSOFT WORD). Once the passive comment actuator is made active, the server may be ready to receive comment data or, an additional action such as a mouse button actuation may be required to cause the server to be ready for the comment data.

The computer code may be derived from the Third Party server, or from another entity, such as a commercial entity providing fee-for-service by providing web administrator's the computer code to import into their webpages that enable the end users to post comments on the administrator's website and concurrently on the Third Party's website.

As a non-limiting example, the comment actuator may be an additional image layer embedded into, overlaid on top of, and/or surrounding the image, video and/or audio content such that, when an end user and/or website operator actuates the comment actuator the comment actuator may function to receive and act upon an end user comment. For example, when the end user and/or website operator is clicking, with no other keyboard input, the comment actuator may function to submit an end user comment solely to first server 120. In another non-limiting example, this end user comment submit function may bring up a comment field and/or button for further keyboard input from the end user and/or website operator, and/or actuate the transmission of the end user comment to a second server 120 and/or any other element of network 130.

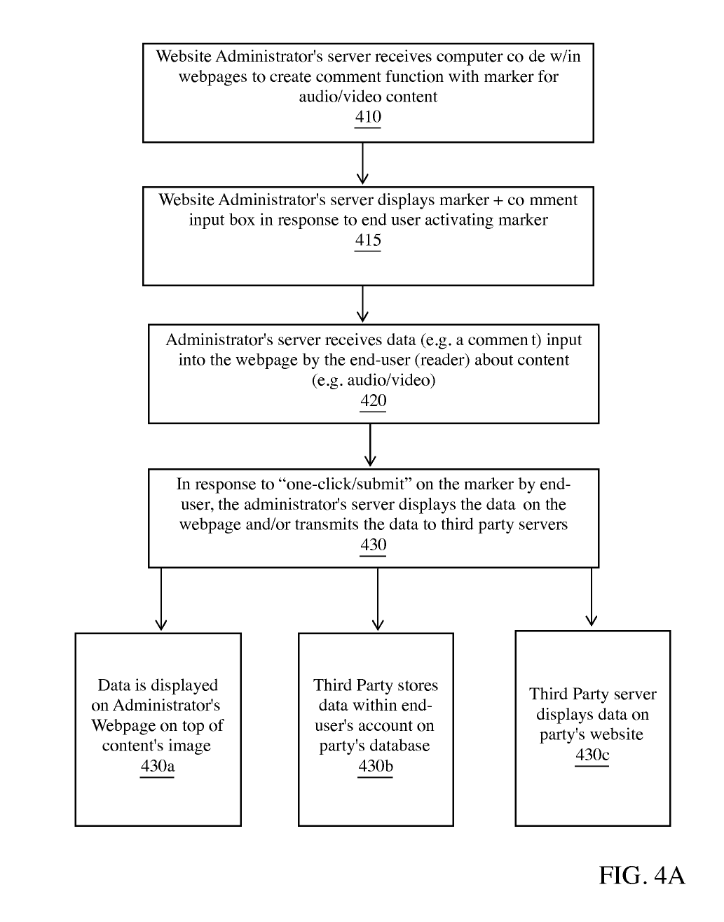

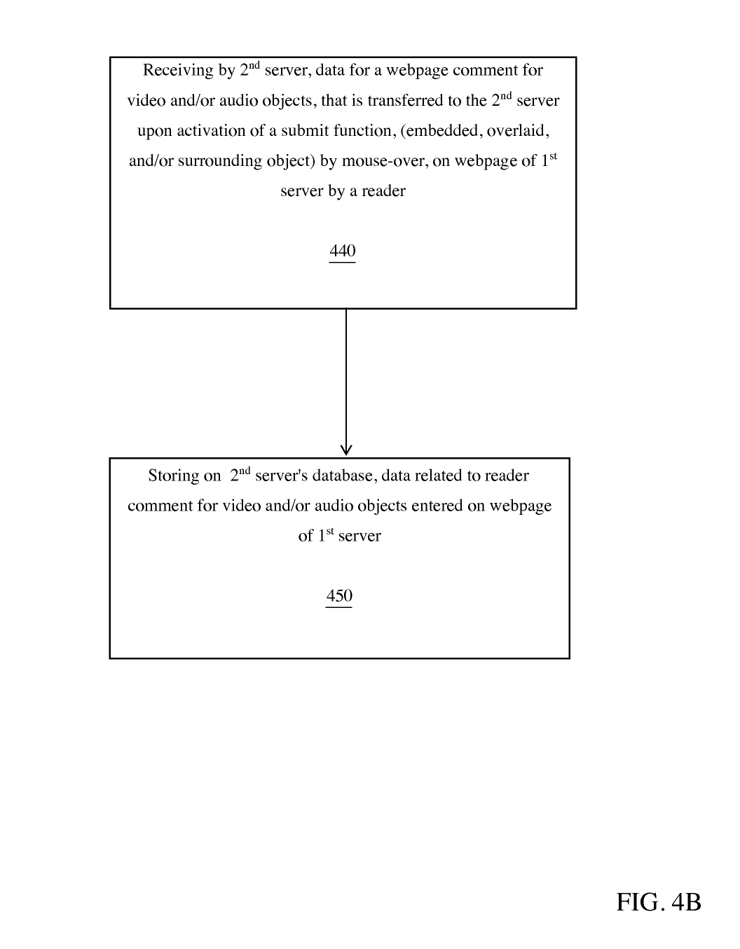

FIG. 4A is a flowchart outlining exemplary actions for an implementation of this embodiment of the content commenter. The actions depicted in FIG. 4A are taken from the perspective of the first server 120. The first server 120, hosting the viewed website, incorporates electronic programming to perform the actions enumerated in the following paragraphs.
(1) A webpage of the viewed website is modified to have an end user comment submit function (step 410) added. In this embodiment, the comment submit function includes, but is not limited to, a comment actuator that is not readably discernable in a normal or steady state. The comment actuator is configured to be visibly displayed or audibly acknowledged upon the end user performing an action or upon the detecting of a state change that is associated with or tied comment actuator. For instance, rolling the pointer of a mouse over certain content may result in the content changing slightly to indicate that a comment submit function is available or, performing other actions as previously mentioned. Such a change may include graying of an image, adding a border around an image, making an audible sound, revealing a tag on or near the image, etc.
(2) The first server 120 is further configured such that when the presence of the comment actuator is revealed, in response to actuation of the comment actuator by the input of the end user, further actions to receive a comment may be performed. For instance, in one embodiment, simply by hovering over the image with the mouse pointer may be considered sufficient actuation to open a comment input field to receive a comment from the end user. In other embodiments, the user may be required to click a mouse button, perform a gesture, make a verbal command, etc. to cause the server to solicit or open up a comment input field capable of receiving end user and/or website operator input (step 415). Yet in other embodiments, hovering over the content may result in the display of a menu with several default comments, such as like, dislike, recommend, etc. or include a menu item for a custom comment.
(3) The first server 120 also is configured, via the end user comment submit function, to receive an end user comment (step 420) in any of the previously listed manners or other manners.
(4) Once the comment has been identified or received 430, the first server 120 may perform one or more of the following actions:
   (a) display the end user comment (step 430a);
   (b) transmit, via network 130, the end user comment to the second server 140 hosting the target website for storage in association with the account of the end user (step 430b); and/or
   (c) transmit, via network 130, the end user comment to the second server 140 for display on the target website (step 430c).

FIG. 4B is a flowchart diagram presenting exemplary actions that may be included in an implementation of this embodiment. In FIG. 4B, the actions are presented from the perspective of the second server 140. The second server 140, hosting the target website, incorporates electronic programming such that:
(1) second server 140 receives an end user comment related to the webpage content (step 440); and
(2) the second server 140 stores in an end user's digital account the end user comment and/or the particular content and/or displays it within the content of the target website (step 450).

### Embodiment (3)

### Travelling End User Input Device

In this particular embodiment, in addition to are alternatively to the first server hosting the viewed website inserting comment actuators into the website, a modified browser is utilized to view and comment on the content. The first server may includes the modified browser as web based browser application or the end user device may incorporate the browser such that it is executed by or on the end user device. In either case, the modified browser includes the capacity to create webpages that enable the end user to transmit webpage content (audio, video, photo image, text, etc.) with or without the end user's comments to a remote second website server database, and/or webpage. Further, the web browser may also include, or alternatively include, the ability to view a standard, non-comment actuator modified webpage, through a lens or overlay that includes comment actuators or allows the user to define locations or content for comment actuators. Thus, instead of the webpage of viewed website being modified, the special browser is utilized to perform the commenting functions. The modified web browser may be configured such that it inserts a comment actuator that is in some manner associated with content of the webpage or on a toolbar option on end user device 110.

As such, the modified or extended browser, whose capacity may be extended (e.g. via Alexa, Delicious or Diigo) enables an end user to identify content from the webpage (e.g. by selecting text, audio, images, and/or video) and input textual, audio, and/or video comment(s) regarding the content. These comments can then be transmitted with or without the content to second website server 140 for display and/or storage in a manner that may be associated with the end user.

This embodiment thus comprises a web browser whose capability has been extended to enable the following functions: (1) a selection feature—to allow the selection of arbitrary text or web objects; 2) a submitting feature—for transmission of that selected page element to a centralized website; and 3) a commenting feature—for adding comments to go along with the transmission of the selected text or web object information to a centralized website. Thus, as a specific example, in response to a user selecting a portion of text displayed on a news feed website, such as GOOGLE news, the modified browser may display a comment actuator to allow the user to insert a comment and send the comment, with our without the selected text, to the target website.

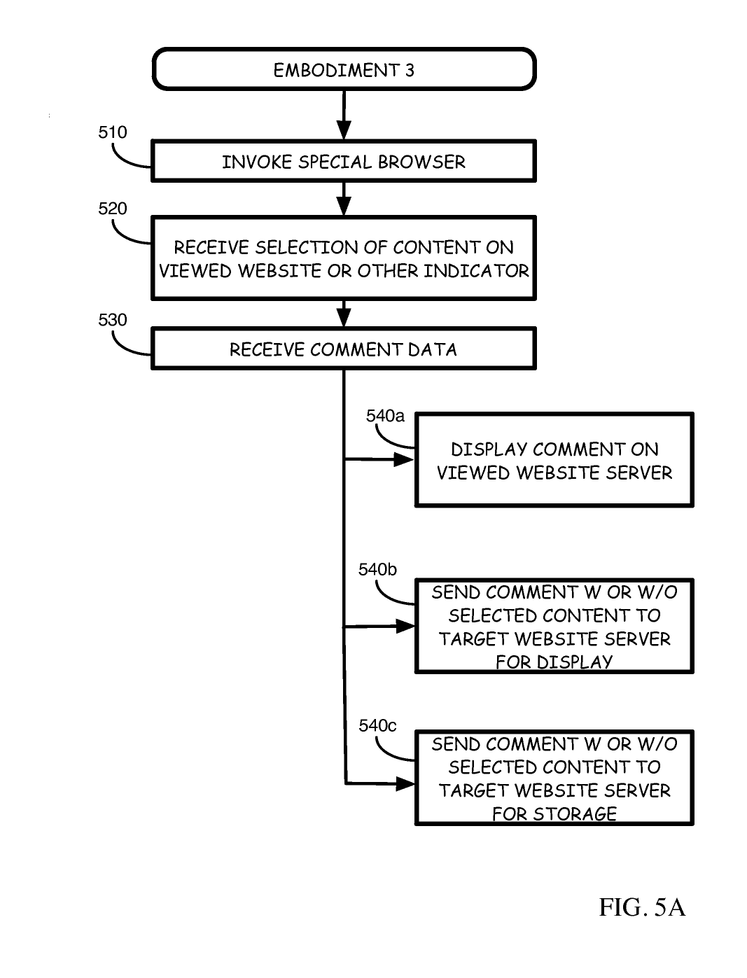

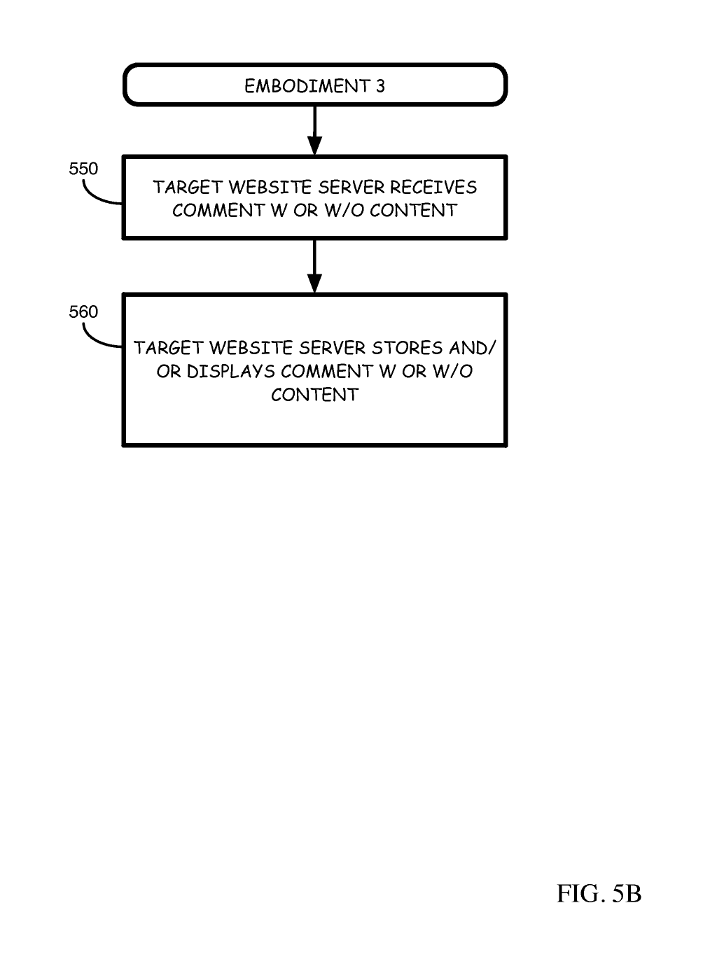

FIG. 5A is a flowchart presenting exemplary actions that may be incorporated into an implementation of this embodiment. Initially, a user accesses the viewed website that is hosted on the first server 120 utilizing the modified browser 510. While viewing the web content, the user may select or identify particular content on the viewed website 520. This could be accomplished simply by selecting text, selecting one or more images or icons, etc. The modified browser may then either prompt the user to enter a comment, select a comment from a pull down list, or simply receive the input of comment data 530. The remaining operations may include one or more the following actions:
(a) displaying the end user comment on the viewed website 540a;
(b) transmitting, via network 130, the end user comment (with or without the selected content) to the second server 140 hosting the target website for storage in association with the account of the end user 540b); and/or
(c) transmitting, via network 130, the end user comment (with or without the selected content) to the second server 140 for display on the target website 540c.

FIG. 5B is a flowchart diagram presenting exemplary actions that may be incorporated into an implementation of this embodiment. The illustrated actions include the second server 140 receiving the comment data and potentially the selected content from the viewed website that is associated with the comment. Further, the second server 140 stores the comments and possibly content in a manner associated with the account of the end user or displays the comment and/or the selected content 560.

### Image Comments Patent

One aspect of this embodiment may comprise an end user submitting an online image as a comment either related to content on a viewed website or maybe even independent thereof. As a non-limiting example, such an image may be from storage on a device or a photograph taken with a device containing a camera (e.g. smartphone). The image can be submitted as a comment that is transmitted and displayed on a webpage of the target website at a remote or second website server.

The various embodiments thus may comprise a computerized process for receiving and managing image comments. The image comments may be input or received from a reader that is associated with a particular webpage. The particular webpage is configured to display a comment actuator that operates as a reader image comment function and is configured to receive image data from an image. The image can be received from one or more of a variety of sources, such as a file, a remotely connected camera, or a built-in camera on a computer, laptop, mobile phone, or tablet, or other image capture device, by a reader of said webpage displayed by said first website server. The process operates to: (1) receive the image data at the viewed content server, as well as any additional comments related thereto; (2) transmit the image comment to the target website server; (3) receive the image comment at the target website server; and, (4) storing at target website server, using a database that is remote from one used by the viewed website server the image comment.

### Audio Comments

Another aspect of this embodiment may comprise the end user recording audio comments associated with content on a webpage of a viewed website on a first server, and then transmitting the audio file to a target website server. The received audio comment can be playable at the target website server. For example, the website of the target website server may aggregate audio comments from multiple end users.

The various embodiments may thus comprise a computerized process for receiving and managing audio comments. The audio comments may be received from a reader that is associated with a particular webpage The particular webpage is configured to display comment actuator that functions as a reader audio comment function and is configured to receive audio data recorded from a microphone, Bluetooth headset, or other audio recording device. The process operates to receive the audio comment from the user and then deliver the audio comment, with or without the content related to the comment, to the target website server for storage and or display. The received comment can then be played by viewers of the target website containing the audio comment.

### Textual Comments on Audio Files

Another aspect of this embodiment may comprise the end user creating textual comments associated with audio content presented on a webpage. The textual comments can then be transmitted to the target website server. The textual comment may optionally refer to the entire audio file, to a particular time in the audio file, or to a segment of the audio file. The referred to audio segment may or may not be transmitted along with the textual comment to the remote second website server.

The various embodiments may thus comprise a computerized process for receiving and managing (textual) comments from a listener. The textual comments may be associated with an audio file displayed or accessible through a particular webpage. The particular webpage is configured to display a comment actuator to operate as a listener comment function. In operation, the server hosting the viewed website receives data related to a comment entered by a viewer and optionally information about the time or range of times the viewer has selected in the audio file and then, to send the comment with or without the audio file or portion thereof to a target website server for storage and/or display. A viewer at the target website can then access the comments and potentially the relevant audio.

### Video Comments

Another aspect of this embodiment may comprise the end user submitting video comments associated with content on a webpage of a webpage of a viewed website. The video commenting could one or more of: an online video, a video from storage on a device, and/or a video created on a device with a camera (e.g. smartphone). The video comment can be transmitted with or without the “commented on content” to a webpage of a remote second website server.

The various embodiments may thus comprise a computerized process for receiving and managing video comments from an end user. The video comments are associated with a webpage or content available on a webpage. The viewed website is configured to display a comment actuator that operates as a video comment function. The viewed website and server thus operates receive video data from one or more of a variety of sources such as, but not limited to, a video file, a remotely connected video camera, or a built-in video camera on a computer, laptop, mobile phone, or tablet, or other video capture device. In operation, the server hosting the viewed website receives the video comment and sends it, with or without the related content, to a target website server for storage and/or display. At the target website server, a viewer can access the video comment and potentially the underlying content.

### Textual Comments on Video Files Patent

Another aspect of this embodiment may comprise the end user creating textual comments on a video file available on the viewed website and, transmit the comments and potentially the video file to a target website for storage or display on a webpage of the target website. The comment may optionally refer to the entire video file, to a particular time in the video file, a portion of the video file, a clip from the video file or to a segment of the video file as a non-limiting example. The referred to video segment may be transmitted along with the comment to the second website.

The various embodiments may thus comprise a computerized process for receiving and managing comments from a viewer that are associated with a video file available on the viewed website. The viewed website is configured to include a comment actuator associated with a video file modified to provide a viewer comment function. In operation, the viewed website server is configured to receive data related to a comment entered by a viewer of the content and optionally information about the time or range of times the viewer has selected in the video file. The process receives the comments and then transmits them to a target website, with our without the underlying related content. A viewer accessing the target website can then access the comments and potentially the video related to the content.

### Audio or Video Comments on Video Files Patent

Another aspect of this embodiment may comprise the end user creating an audio or video comment on a segment of a video file and having the comment and segment transmitted to a target website server. An audio comment may be mixed with the original audio of the video segment or it may replace it entirely. A video comment may be superimposed on the original video segment to create a “Picture-In-Picture” video.

The various embodiments may thus comprise a computerized process for receiving and managing audio or video comments from a listener that are associated with a video file displayed on a viewed website. The viewed website includes a webpage and/or a video file configured to display a comment actuator the provides an audio or video comment function. In operation, the viewed website server is configured to receive audio data recorded from a microphone, Bluetooth headset, or other audio recording device, or video data from a file, built-in, or remote video camera by a viewer of the content and optionally information about the time or range of times the viewer has selected in the video file. The viewed website server receives the audio and/or video comment and transmits it, with our without the underlying content, to the target website server. The viewed website server or the target website server may optionally creating a new video file with the comment audio superimposed on the portion of the original video file or the video superimposed in a “Picture-on-Picture” fashion on the original video file that was commented upon. A viewer of the target website can then access the content and comment.

### Embodiment (4)

### Sponsored Comment

In this particular embodiment, first server 120, hosting an operator's website, incorporates electronic programming such that a webpage of operator's website is modified to have an end user sponsored comment submit function wherein the end user may select and/or pay to have the comment displayed distinguishably from non-sponsored comments on the operator's website and/or the third party website hosted on second server 140.

When allowing comments to be put on a display medium such as a webpage or a mobile device, the website administrator of that page can choose to allow the website end user visitor to pay to have their submitted comment stand out in some way so that the comment appears as a “sponsored comment.”

Non-limiting examples of how to “distinguishably display” comments can be accomplished by:
(1) the comment appearing toward/at the top of the list of comments generated by other end users; and
(2) the comment's border being highlighted by a color frame and the comment appearing to the left or right side of the non-sponsored comments.

Non-limiting examples of how selecting and/or paying is accomplished includes a check box, a drop down menu option, credit card payment processing applets, etc.

As a non-limiting example, the sponsored comment submit function may be an additional image layer embedded into, overlaid on top of, and/or surrounding the image, video and/or audio content such that, when an end user and/or website operator actuates the sponsored comment submit function, the sponsored comment submit function may function to receive and/or submit an end user comment. For example, when the end user and/or website operator actuates the comment actuator, the sponsored comment submit function may function to submit an end user comment to viewed website server 120 and/or a target website server. In another non-limiting example, this sponsored comment submit function may bring up a comment field and/or button for further keyboard input from the end user and/or website operator, and/or actuate the transmission of the end user comment to a second server 120 and/or any other element of network 130.

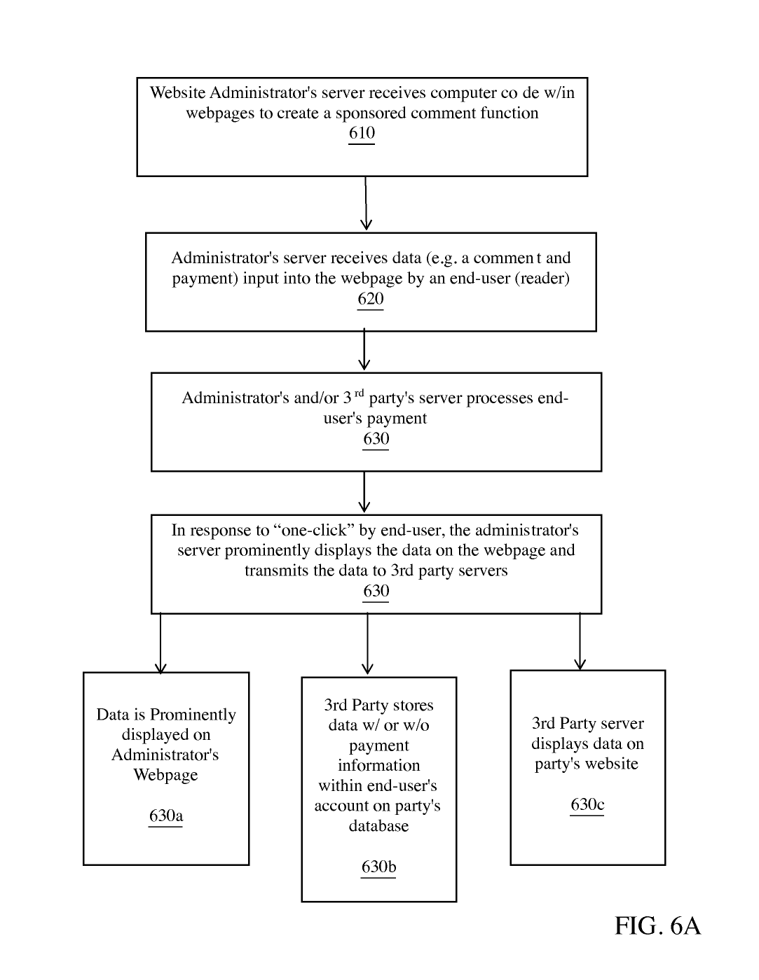

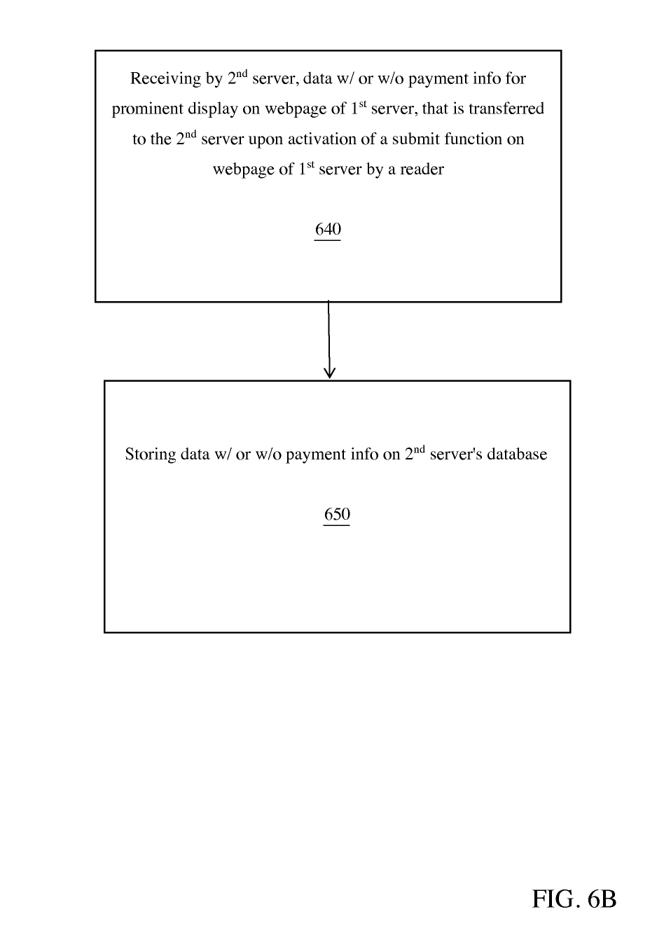

FIG. 6A is a flowchart diagram illustrating exemplary actions that may be implemented in this embodiment. The first server 120, hosting an operator's website, incorporates electronic programming provide this functionality. A webpage of the viewed website is includes a comment actuator that functions as an end user sponsored comment submit function 610 comprising a selection and/or payment module. The first server 120 receives a sponsored end user comment and payment information from the end user 620 when the end-yser actuations the comment actuator. The first server 120 processes the payment information from end user 630 and then operates to display the end user sponsored comment 640a; transmit the end user sponsored comment to the target website server 140 hosting a target website for storage; and/or display. Optionally, the first server 120 may be configured such that first server 120 displays a comment field capable of receiving end user and/or website operator input. Alternatively, the comment field may not require actuation to be displayed (step 615).

FIG. 6B is a flowchart outlining aspects of this embodiment from the perspective of the target website server 140. The target website server 140, hosting the target website, receives the sponsored comment 650 and then stores it in association with the end user account or displays it on the target website as previously presented.

### Embodiment (5)

### Reward for Commenting

Another aspect that may be incorporated into various embodiment of the content commenter includes the end user being awarded points for commenting on content available on a viewed website. The end user may then use or “spend” the points for a variety of purposes, such as: 1) to win a prize redeemable from the hosting or owning entity of the viewed website or other third party; and/or, 2) to purchase “sponsor points” for the website end user's comment to rise on the list of all website end user comments on that webpage to a more prominent position, or to be highlighted in some other way (as per Embodiment (4)).

An end user may earn points in any of a wide a variety of methods. For example, each time a first end user comments on a viewed website or, a participating viewed website, the end user may earn one or more points. Additionally, each time another end user (e.g. second, third, etc.) rates the first end user's comment favorably, such as in “liking” that comment, commenting on the first end user comment, or giving it a higher rating (e.g. a scale of 1 to 5), the first end user receives some number of points depending upon the activity and/or how high the rating is. And the rating website end user (second, third, etc. end user) may similarly receive some reward points for making the rating of the first end user's comment.

Additionally, other actions can also be taken such as including schemes for deducting points from an end user's total when other end users (e.g. second, third, etc. end users) reject or strongly disagree with the first end user's comments. For example, if the first end user adds comments that are considered offensive, factually inaccurate, etc., the first end user may be penalized by other end user's by having their total number of points be reduced at the discretion of the website administrator.

The various embodiments may allow a website administrator to choose to allow website end users to accumulate and spend points gained via their commenting activities either on a certain website or mobile app, and/or by the central site hosting, for example, the code where the website administrator obtains the code to put on his individual page, and where, website end users have their own private accounts where all their comments from around the web are aggregated.

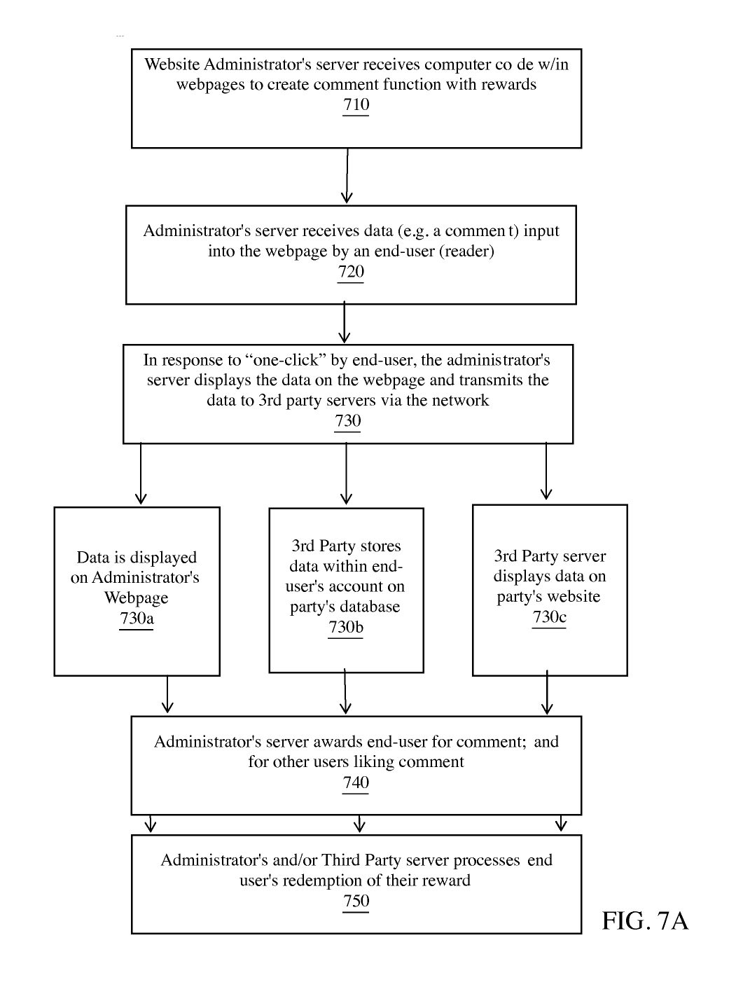

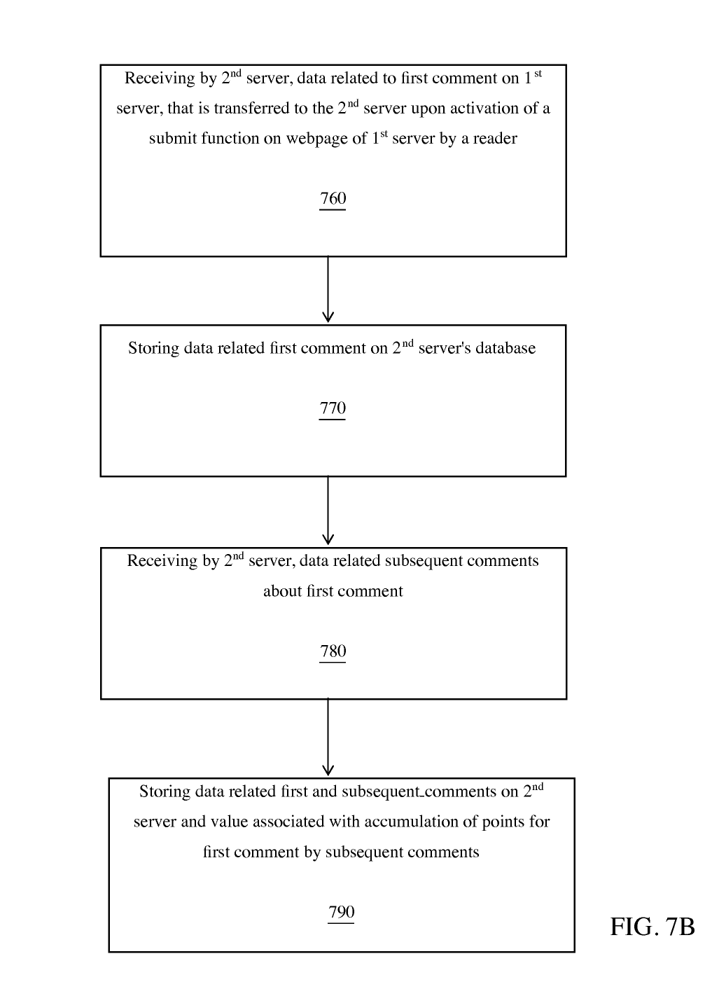

FIG. 7A is a flowchart presenting exemplary actions that may be included in various embodiment of the content commenter. Initially, the viewed website server receives computer code within the webpages, or receives webpages so configured to allow for the provision of a comment function that also may include a reward function for giving a reward to the commenter by the viewed website server or by another entity (e.g. commercial entity who has contracted with the first website administrator to reward end users with their product/service) 710. The viewed website server receives data (e.g. a comment) input into the webpage by an end user (reader) 720. In response to the input, which may be entered using any of the methods described herein as well as other methods, including but not limited to a “one-click/submit”, the viewed website server displays the comment data on the webpage in a prominent position (e.g. at the top of a list of comments) and/or transmits the data to a target website server 730. Therefore, the following events may occur simultaneously: comment data is prominently displayed on the webpage of the viewed website server 730a; the target website server receives and stores the comment data within end user's account on that server's database 730b; and in addition, the target website server displays (prominently or not) the comment data on the target website 730c. The viewed website server and/or target website server awards a first end user for submitting a noteworthy comment; and/or for other (second, third, etc.) end users submitting their own comment stating that they “like”, “agree with”, etc. the first end user's comment 740. Finally, the viewed website server and/or target website server processes the first end user's redemption of their reward.

FIG. 7B is a flowchart diagram illustrating further exemplary actions that may be included in the embodiment presented in FIG. 7A. The target website server receive data related to a comment and associated with content on the viewed website 760. The received data may typically be transferred upon the end user actuating a submit function displayed on the viewed website or otherwise actuating a comment actuator. The target website server may then operate by storing into a database that is remote from target website server the received comment data 770. The comment data can then be displayed by either the viewed website server and/or the target website server in such a way that allows the triggering of a second reader comment function regarding the comment. This triggering may comprise the actions of: receiving at the target website server data related to a comment and associated with the content on the viewed webpage 780. As previously described, the data can be transferred as the result of various actions. The data may be stored at the target website server, using a database that is remote from the viewed website server 790. The stored data may include the comment that was entered by said the end user, webpage text or object at the viewed website server along with accumulation of points associated with the commenter(s); said accumulated points being given some virtual or actual value and can later be redeemed for virtual or actual value.

### Embodiment (6)

### End User Comment Posting En Masse

Another aspect that may be incorporated into various embodiments of the content commenter comprises including computer code or functionality on an entity's website (e.g. first website) from a Third Party centralized website housing or hosting the website. When the website includes an end user's personal account, this aspect enables the end user to enter a comment in their personal account (e.g. a second website) that is then simultaneously displayed on the first website. In response to an end user action, such as clicking a button or actuating a comment actuator, the viewed website server will transmit computer code or data to the end user's account on the Third Party server. Subsequently, any time the end user enters a comment into their account on the Third Party server, the comment will be posted on any selected subset or all of the webpages associated with their personal account (e.g. blog) and concurrently on the first website from which the end user originally derived the code.

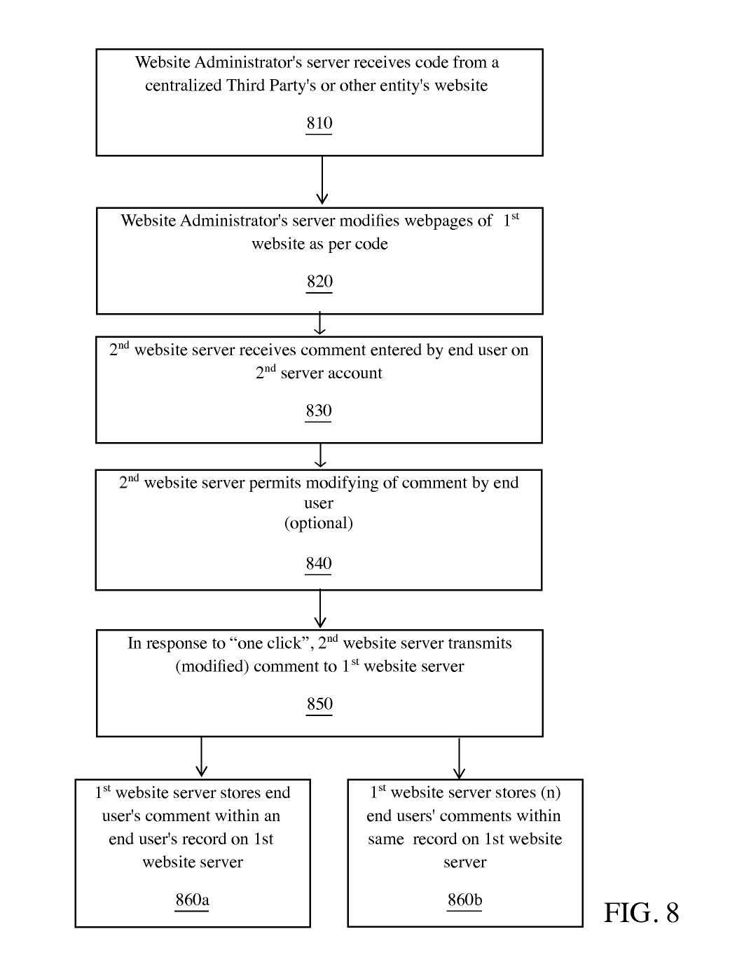

FIG. 8 is a flowchart illustrating the method of sending comments from an end-user's account on a third party server to multiple websites simultaneously. As a non-limiting example, this aspect may be implemented into various embodiments of the content commenter by including the following process. Initially, a first website server (e.g. see FIG. 1, website server 120) receives computer code from a second website server (e.g. Third Party server 140—or other entity) enabling the transmission and display of comments entered on the second website server (140) to the first website server (120) 810. A first website server, in accordance with the code, displays a webpage modified to receive and display a reader comment function (e.g. within a reader's record/file on the first website server) 820. A remote second website server (e.g. Third Party's) receives data comprising a reader's comment entered by an end user into their record/file on the second website server 830. The second website server displays a list of reader comments (e.g. chronological) and comment fields created by an end user with an option to modify or add additional text to the comments 840. The second website server transmits comment data (modified and/or original) to the first website server in response to the end user actuating a submit function displayed on the webpage presented by the second website server 850. The first website server may then operate to receive, display and store comment data from an end user within their record/file on the first website server 860a. In another embodiment, the first website server may operate by receiving, displaying and storing comment data from multiple end users (n) within the same record on the first website server 860b.

In one example for this embodiment (e.g. step 860a implementation), patients may import computer code (via a click or entry, as a non-limiting example, of a username and/or password to have the code placed on their site) from their doctor's or hospital website onto their personal journal site so that they can give daily or weekly updates on their progress regarding a medical condition. Rather than logging into the doctor's site, they can do it from their own journal site, and with “one-click” the comment data is transmitted, stored within, and displayed on their account with the doctor/hospital. With “one-click” the reader may also simultaneously transmit their comment(s) (e.g. a chronology of daily comments on medical progress) to multiple third party servers, comprising for example another (specialist) doctor's website, or a website for receiving their comments (or other forms of input data) related to a completely different issue (e.g. physical therapist, billing, etc.).

In another example of this embodiment (e.g. step 860b implementation), all team members on a project can provide updates for their progress by entering comments in their personal website journal, that are then transmitted and displayed along with other team members comments on a “project” website. The team can then view all comments made by each team member on the team's record/file on the first website server.

And in yet another example of this embodiment, students providing comments related to assignments from their personal journal site may instantly post their comment to the classroom site along with other students' comments (step 860b).

### Exemplifications

### Comments on Locations

An exemplification of any one of the embodiments presented herein as well as variations thereof may comprise the end user creating a comment (text, audio, video, or photograph, or any combination of these) on a physical location using a location-aware device, such as a cell-phone or tablet, at a first website server. The comment is then transmitted to a remote second server, where it is stored in the database and/or displayed on the website of the second server.

In such embodiments, the end user utilizes a cellphone, portable computer, laptop, tablet, or other computational device. The device displays either a webpage or app display with the option of commenting on a location. The end user's location, or a desired comment location, is provided to the device via an internal GPS signal, a location determined by cell towers, an external location device, a map on which the end user may select a location as well as other techniques or combinations of any techniques. The end user makes a comment about the location or a building or event or art object or other unique element at that location. The comment may be text, audio, video, or photograph, or any combination of these. The end user engages a display element on the device that causes the textual, audio, image, or video comment to be sent to a a target website server. Subsequently, others accessing the target website may then view the end user's comment.

### Viewing Comments Based on Location Information

Another exemplification of any one of embodiments presented herein as well as variants thereof may comprise the end user creating a collection of comments (text, audio, video, or photograph, or any combination of these) with location data that can be displayed to a viewer. Optionally, the comments are displayed in order of distance from a specified location (e.g. the current location of the viewer). Alternatively, the viewer may specify a geographic region of interest and all comments within the region are displayed.

The various embodiments may thus include the action of storing a textual, image, audio, or video comment(s) (e.g. data) that are associated with identified geographic locations in a database of a second website server. Access to the database is provided by the second website server which displays the comments either in a web browser or on an app in a computational device such as a computer, phone, tablet, or laptop. The device's graphic user interface allows the end user to specify either a specific location or a region. If a specific location is selected, the comments are displayed in order of distance of the comment location from the viewer's specified location. If the viewer selects a region, then all comments whose locations are in the specified region are displayed.

### Comments on Events

Another exemplification of any one of embodiments presented herein as well as variants thereof may comprise the end user creating a comment on an event and having the comment transmitted to a second website. Optionally, the comment may be created on a portable device with location and time information, such as a cellphone or tablet and be associated with an event occurring near that location and time.

In such an embodiment, an end user utilizes a portable computational device, such as a cellphone, laptop, or tablet, at an event to perform the commenting function. The device displays either a webpage or an app display allowing input by the en-user comprising a comment about the event. The end user creates a textual, image, audio, or video comment about that event on the device. The device records the time and location that the comment was created. The end user engages a graphical user interface element to cause the comment, along with location and time information, to be transmitted to a database in a server for a second website. End users of the second website can see the comments associated with the event near and the comment's recorded time and location.

### Comments on Physical Objects

Another exemplification of any one of embodiments presented herein as well as variants there of comprise the end user creating a comment on a physical object and having the comment transmitted to a second website. Examples include, but are not limited to: pieces of sculpture, pieces of art, commercial products, books, or historic landmarks. Viewers can access comments associated with the physical object.

In such embodiments, an end user has a portable computational device, such as a cellphone, laptop, or tablet at an event. The device displays either a webpage or an app display allowing a comment about an object including but not limited to: pieces of sculpture, pieces of art, commercial products, books, or historic landmarks. The end user creates a textual, image, audio, or video comment about that event on the device. The device records the time and location that the comment was created. The end user engages a graphical user interface element to cause the comment along with location and time information to be transmitted to a database in a server for a second website. The end users of the second website can see the comments associated with the object and the comment's recorded time and location.

### Comments on News

Another exemplification of any one of embodiments presented herein as well as variants thereof may comprise the end user creating a comment on a news story which is transmitted to a second website. Viewers can access the comments associated with the news story.

In such embodiments, an end user has a computational device, such as a cellphone, laptop, or tablet that is displaying a webpage showing a news story with text, audio, image, and/or video content. The device displays a graphical user interface function allowing a comment about the news story. The end user creates a textual, image, audio, or video comment about the story on the device. The end user engages a graphical user interface element to cause the comment along with the identity of the news story to be transmitted to a database in a server for a second website. The end users of the second website can see the comments associated with the news story.

### Comments on Two or More Items

Another exemplification of any one of embodiments presented herein as well as variants thereof may comprise the end user creating comments that refer to two or more websites or items. Such comments include, but are not limited to, comments comparing the two items, describing how the two items differ, or how the two items may be used together. Viewers can access such comments from any of the items they refer to.

In such embodiments an end user has a computational device, such as a cellphone, laptop, or tablet that is displaying a webpage showing an item of interest to the end user either as text, audio, image, and/or video content. The device displays a graphical user interface function allowing the end user to select that item and have it stored in the database of the device. The end user may then navigate to one or more other webpages comprising other items, which may be selected. The end user creates a textual, image, audio, and/or video, or any combination thereof, comment about the multiple selected items. This includes but is not limited to comments comparing the items, describing how they differ, describing how they may be used together. The end user engages a graphical user interface element to cause the comment along with links to the selected items to be transmitted to a database in a server for a second website. The end users of the second website can see the first end user's comments along with links to each of the selected items.

### Comment Rewards

Another exemplification of any one of embodiments presented herein as well as variants thereof may comprise a person or an organization soliciting comments on a product, service, location, website, audio, video, text, person, or other entity. Commenters agree to allow the soliciting person or organization to highlight their comment in advertising, websites, or audio, video, or text content. If a comment is selected, the soliciting person or organization agrees to reward the commenter with a stated reward including but not limited to: a monetary amount, discounts on products, admission to events, and/or higher grade of service.

In such embodiments, a commercial organization creates a webpage soliciting comments on their product. The webpage may include graphical user interface elements allowing the end user to make textual, audio, image, and/or video comments on the product. The end user engages a graphical user interface element to cause the comment to be transmitted to a remote second website server and stored in a database. The organization selects submitted comments to be highlighted on the webpage of the second website server. If a comment is chosen to be displayed, the organization agrees to reward the commenter with a specified reward. These may include but are not limited to: monetary reward, discounts on products, admission to events, and/or a higher grade of service. The chosen commenter is presented his reward through email, physical mail, or on a Third Party commenting website.

### Comment Collections

Another exemplification of any one of embodiments presented herein as well as variants thereof may comprise the end user commenting on previous comments that were left by the end user or others and, collecting the comments into groups. The end user may provide a numerical or other form of rating or tagging indicating which comment was most valuable to them.

In such embodiments a social website displays an end user's comments. The site provides graphical user interface elements that allow comments to be selected by an end user. The end user's selected comments may be stored in a database on the server and/or displayed on his own webpage. The interface elements enable the end user to provide his own comments on such previous comments and store them in the database. The end user comments may be displayed on the end user's own webpage and/or on the webpage of the original comment. The graphical user interface elements may be displayed on his webpage to thus present or provide access to the comments and, which allow the end user to rate the comments according to his liking of them. The comments may be displayed according to the entered ranking End user names may be displayed according to the end user's average ranking of their comments. End users may be shown comments of other end users according to their rankings of comments.

### Display of Friend's Comments

Another exemplification of any one of embodiments presented herein as well as variants thereof may comprise displaying of contextually appropriate comments created by persons known to a viewer (e.g. a friend), including but not limited to: billboards, video presentations, websites, and web searches. This aspect also comprises highlighting and/or annotating relevant comments of friends.

In such embodiments a social media site collects comments from users about products which are being advertised on websites, billboards, television, radio, or other locations. This may occur according to a variety of methods or techniques, including such methods and techniques described in U.S. Pat. No. 8,402,357, or as otherwise described in any related Social Commenting, LLC patents, the contents of which are herein above incorporated in by reference. The social media site also may maintains a database of the friends and associates of each user. The social media site may provide the opportunity for the product owner to pay for advertisements that include the comments of a user's friend or associate for display specifically to the end user. A non-limiting example is to use location based information from the end user's smartphone, or other portable computing device comprising GPS functionality, to determine the end user's proximity to a billboard or other advertising display and present the targeted social ad from the friend or associate on that display. Another non-limiting example is to display targeted friend-based ads on websites visited by a user. Another non-limiting example is to display targeted friend-based ads on video programs being watched by the end user.

### Comment Rating and Categorization

Another exemplification of any one of embodiments presented herein as well as variants thereof may comprise the ability of the end user to rate or rank the comments of others; and, categorize the comments according to those who rank them highly and/or their rankings and/or the categorization of viewers according to the comments they rank highly. This aspect comprises the utilization of categorization algorithms, such as singular-value decomposition. This aspect may further comprise, the selective display of comments that have been ranked highly by end users similar in taste to the viewer.

In such embodiments a social media site collects comments from users in any of the ways previously described herein and in the incorporated references. Each end user of the social media site is able to provide rankings of other's comments. This is done by providing a user interface element on the comment webpages in which a user may indicate a numerical ranking of the value they find in the comment. The user's identity, his ranking, the commenter's identity and a link to the comment are stored in a database on the social media site's servers. The processing of comment rankings are computed on the social media site's servers according to well-known clustering and categorization algorithms. For a non-limiting example, the singular value decomposition may be applied to the matrix of weights between users and comments. The result of running these algorithms is to cluster the end users into groups with similar ratings of comments and to cluster comments into groups which are rated similarly by similar users. The display elements are provided to end users to allow them to display only comments from users that are similar to those they have rated highly. The display elements are provided to end users to allow them to display only comments which are in clusters which are highly rated by them.

### Affiliate Friend Comments

Another exemplification of any one of embodiments presented herein as well as variants thereof may comprise the ability of an-end user to allow his or her comments to be used in ads in return for a percentage payment if friends buy through those ads.

In such embodiments a social media site collects comments on products from its users using one of a wide variety of techniques. End users may agree to allow their comments on a product to be displayed in advertising that is to be displayed to their social media friends and associates in return for a pre-specified affiliate commission. End users who have thus entered into such an agreement will typically have their comments displayed and/or stored in a database on the social media site's webserver. The friends and associates of the end users who have agreed are determined. The social media site offers advertising opportunities to companies selling products which have been commented on by users who agree to affiliate advertising. A database of companies purchasing this advertising may be created. Advertisements including comments from agreeing users are displayed to their friends and associates on the social media site. If a friend or associate selects the advertisement and purchases the product, then the pre-specified commission is paid to the agreeing commenter.

### Comment Offers

Another exemplification of any one of embodiments presented herein as well as variants thereof may comprise presenting an end user with an opportunity to comment on a product immediately after the end user finishes using the product. Product types, include but are not limited to: reading a book, watching a movie, listening to a recorded audio program or music, reading an article, usage of a commercial service, etc. The server presents the end user with an immediate opportunity to comment. The comment may be associated with a reward, and/or may be aggregated with other comments on that product or service.

In such embodiments a social media site presents a user interface element for a user to make a comment immediately after consuming a piece of media. Some non-limiting examples of media consumption include: reading a news story, reading a blog post, reading a book, reading a magazine article, listening to a recorded audio program, listening to recorded piece of music, viewing a movie, viewing a video program, usage of a commercial service, usage of a software or app program, etc. The web-based or software viewer for the media is configured to display a user interface element that allows the end user to make a comment. The user may be offered a reward for commenting. The user enters the comment via text, audio, image, and/or video. The user selects a user interface element to cause the comment to be transferred along with the user's identity and the identity of the media consumed to a database on a second server. The social media site may display the comment on the user's own social media page and on the page associated with the content that the user consumed.

### Comment Search Using Image Recognition

Another exemplification of any one of embodiments presented herein as well as variants thereof may comprise enabling the end user to search for comments using image recognition. By taking a picture of an object, location, or person, a database of comments may be searched and comments on the pictured item retrieved. Optionally, comments may be ordered by ranking of how well known the commenter is to the searcher. Optionally, the comments may be ordered according to modeled characteristics or previous searches of the searcher.

In such embodiments an end user utilizes a portable computational device with a camera, such as a phone, tablet, laptop, or other similar device, to take a photo of an object, person, location, QR code or similar code, or product of interest to him. A user interface element on the device allows the image to be uploaded to a server. The image is matched against a database of images that have comments associated with them. Standard image matching algorithms are used to perform the match. These algorithms include, but are not limited to, facial recognition algorithms, object recognition algorithms, pattern matching, and character recognition. The comments associated with any matching images in the database are presented to the end user in a webpage along with their associated images. Optionally, the comments may be ordered by a ranking of how closely connected the commenters are to the user. Optionally, the comments may be ordered according to a learned measure of similarity between the commenter and the user. Also optionally, the comments may be ordered according to their relevance to previous searches by the user.

A number of implementations have been described. Nevertheless, it will be understood that various modifications may be made. For example, elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While various embodiments and features and aspects of those embodiments have been described in detail herein, it is to be understood that the inventive concepts may be otherwise variously embodied and employed and that the appended claims are intended to be construed to include such variations except insofar as limited by the prior art. Possible variations, as described throughout this disclosure, are not to be regarded as a departure from the spirit and scope of the invention, and all such modification as would be obvious to one skilled in the art are intended to be included within the scope of the preceding disclosure and the following claims.

It is understood that any variations of the features of the system and method described in the description section falls within the scope of the invention. There can be many embodiments of this invention as witnessed in some of the figures and the discussions of them. Not all embodiments of the content commenter are represented here.

In the description and claims of the present application, each of the verbs, “comprise”, “include” and “have”, and conjugates thereof, are used to indicate that the object or objects of the verb are not necessarily a complete listing of members, components, elements, or parts of the subject or subjects of the verb.

In the description and claims the words of the present application, each of “program”, “function” and “module” are used interchangeably. Anything designated as a program, function or module may be a stand-alone entity or a specialized module. A program, function or a module may be modular or have modular aspects allowing it to be easily removed and replaced with another similar unit or module. Each program, function or module may be any one of, or any combination of, software, hardware, and/or firmware. Software of a logical module may be embodied on a computer readable medium such as a read/write hard disc, CDROM, Flash memory, ROM, or other memory or storage, etc. In order to execute a certain task a software program may be loaded to an appropriate processor as needed.

What is claimed is:

1. A content commenting system comprising:
a first sub-system configured to present content that can be perceived by end user device;
a comment actuator associated with at least a portion of the content;
a second sub-system configured to:
receive comment data in response to the comment actuator being actuated, the comment data including information to identify the associated content and, comment information pertaining to the content; and
provide the comment data to a third sub-system.

2. The content commenting system of claim 1, wherein the comment actuator further comprises a visible element that is displayed proximate to the content.

3. The content commenting system of claim 1, wherein the comment data is received in response to an end user providing textual input.

4. The content commenting system of claim 1, wherein the comment data is received in response to an end user providing audio input.

5. The content commenting system of claim 1, wherein the comment data is received in response to an end user providing video input.

6. The content commenting system of claim 1, wherein the comment data is received in response to an end user providing graphic input

7. The content commenting system of claim 1, wherein the comment data is received in response to the end user providing any combination of text, audio, video and graphic input.

8. The content commenting system of claim 1, wherein the comment actuator is not visible on the display until the user performs and action that is associated with the content.

9. The content commenting system of claim 8, wherein the action that is associated with the content comprises moving a mouse pointer over the content.

10. The content commenting system of claim 1, wherein the comment actuator is actuated by detecting the selection of content.

11. The content commenting system of claim 1, wherein the first sub-system and the second-subsystem are the same.

12. A content commenting system comprising:
a target server providing a comment actuator to a viewed server such that the viewed server can include the comment actuator as associated with content of a website to be displayed and accessible on an end user device;
in response an actuation of the comment actuator, the target server receiving comment data including information to identify the associated content and comments pertaining to the content; and
the target server rendering information on a target website that enables viewers to access the comment and identify the associated content.

13. The content commenting system of claim 11, wherein the comment actuator is provided in the form of code to be embedded into the website.

14. The content commenting system of claim 11, wherein the code is configured to create a visible element to be displayed along with the content of the website.

15. The content commenting system of claim 11, wherein the code is configured to create a non-visible element that only become visible on the website in response to an end user taking an action relative to the content associated with the comment actuator.

16. The content commenting system of claim 11, wherein the target server is configured to receive comment data in audio form.

17. The content commenting system of claim 11, wherein the target server is configured to receive comment data in video form.

18. The content commenting system of claim 11, wherein the comment data is received in response to an end user providing audio input.

19. The content commenting system of claim 11, wherein the comment data is received in response to an end user providing video input.

20. The content commenting system of claim 11, wherein the content received from the viewed server is audio content and the comment relates to the audio content.

21. The content commenting system of claim 11, wherein the content received from the viewed server is video content and the comment relates to the video content.

22. The content commenting system of claim 11, wherein the target server provides credit points to the end user upon reception of the comment data.
